(19) United States
(12) Patent Application Publication
(10) Pub. No.: US 2010/0045982 A1
(43) Pub. Date: Feb. 25, 2010

(54) PARTICLE COUNTER AND PARTICLE COUNTING DEVICE HAVING PARTICLE COUNTER, AND PARTICLE COUNTING SYSTEM AND ITS USE METHOD

(75) Inventors: Haruhiro Tsuneta, Nagano (JP); Eiichi Sugioka, Nagano (JP); Hiroshi Tonouchi, Nagano (JP); Junichi Shiozawa, Nagano (JP); Kenichi Hayashi, Nagano (JP); Tetsuo Momose, Nagano (JP); Hiroaki Furihata, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano, (JP)

(21) Appl. No.: 12/095,465

(22) PCT Filed: Nov. 28, 2006
(86) PCT No.: PCT/JP2006/323746

§ 371 Date: Sep. 22, 2009

(30) Foreign Application Priority Data
Nov. 29, 2005 (JP) 2005-343221
Nov. 29, 2005 (JP) 2005-344645
Dec. 27, 2005 (JP) 2005-374041
Jan. 30, 2006 (JP) 2006-020464
Feb. 17, 2006 (JP) 2006-041064

(51) Int. Cl. G01N 21/00; G06F 19/00; G08B 21/00

(52) U.S. Cl. 356/338; 702/26; 340/627

(57) ABSTRACT

A particle counting device 11 for detecting and counting particles in a fluid to be measured comprises a measuring section 13 for detecting particles and a control section 12 for processing the output signal from the measuring section 13. When an abnormality occurs, a signal to issue a warning is generated. With this, a constant monitoring or observation is possible. Also, a particle counting system comprising a plurality of particle counting devices 11 and an information processing device 17 for processing the results of the counting by the particle processing devices 11 is also provided. The plurality of particle counting devices 11 are electrically connected to the information processing device 17 in multiple and in parallel. Alternately, a particle counting system comprising a plurality of particle counting devices 11 for detecting and counting particles in a fluid to be measured is also provided. To one of the plurality of particle counting devices 11, the other particle counting devices 11 are electrically connected in multiple and in parallel. Therefore, a particle counting system, the measurement time of which can be shortened while maintaining the accuracy of the measurement results, and its use method are provided relatively inexpensively.

### CROSS REFERENCE TO RELATED APPLICATIONS

This is a U.S. national stage of application No. PCT/JP2006/323746, filed on Nov. 28, 2006. Priority under 35 U.S.C. §119(a) and 35 U.S.C. §365(b) is claimed from Japanese Application No. 2005-344645, filed Nov. 29, 2005; Japanese Patent Application No. 2005-343221, filed Nov. 29, 2005; Japanese Application No. 2005-374041, filed Dec. 27, 2005; Japanese Application No. 2006-020464, filed Jan. 30, 2006; and Japanese Application No. 2006-041064, filed Feb. 17, 2006, the disclosures of which are also incorporated herein by reference.

### TECHNICAL FIELD

The present invention relates to a particle counter for detecting and counting particles in a fluid to be measured, a particle counting device equipped with it, a particle counting system and its use method.

### BACKGROUND

For manufacturing semi-conductor devices and liquid crystal panel devices, the environment of a clean room or clean booth is an important factor to determine the yield of products. Therefore, a particle counter or a particle counting device equipped with a particle counter has been conventionally used for measuring the cleanliness of a clean room or a clean booth. Such a particle counter is configured by a measuring section for detecting and counting particles in a fluid to be measured and a measuring control section for controlling the entire device including the measuring section and for performing various kinds of computations. A measuring result display section is also provided for displaying the measurement results of the measuring section. These sections together configure a particle counting device (see Patent reference 1, for example).

Measuring cleanliness by using a particle counting device is specifically described. First, in a particle counting device, a fluid to be measured of unit volume (28.3L=1 cf, for example) is sampled or sucked at the measuring section. Then, the number of particles detected in the fluid to be measured is displayed at the measurement result display section. The measurement results are often displayed by class numbers. “Class number” means the number of particles per square feet by US Federal Standard 209D, measuring particles having the size of 0.5 μm or larger; they are displayed by class 1, 10, 100, 1000, etc.

In the measurement of cleanliness performed as above, there may be a case in which the measurement result is obtained only as a sum over the entire measuring time. If that's the case, even when the number or amount of particles fluctuates within the measuring time, the fluctuation cannot be observed. Therefore, it is an important objective to shorten the measuring time in order to improve accuracy of the measurement results. It is also important to improve efficiency and productivity in operation.

To shorten the measuring time, there is a method in which one portion of unit volume is sampled or sucked, the obtained counting value is converted into a value per unit volume (by multiplying the obtained value several times to convert it to a standard unit volume), and the converted value is displayed as a measurement result. According to this method, the measuring time (mainly the period of time of sucking a fluid to be measured) can be shortened.

Also, among particle counters, there is a light-scattering particle counter for measuring the number of airborne particles by using a light scattering property (see Patent Reference 2, for example). For example, as shown in FIG. 23, a light-scattering particle counter 1100 irradiates a measuring area 1107 with laser light 1102 and counts particles 1120 present in the measuring area 1107 based on the scattered light 1108 generated by the particles (dust). When the measuring area 1107 contains particles 1120, the scattered light 1108 is generated from the measuring area 1107. The scattered light 1108 is guided to enter a light-receiving device 1110 via a light-receiving lens 1109.

In FIG. 23, the laser light 1102 emitted from a laser diode 1101 is in an elliptic shape; however, as it is transmitted through a cylindrical lens 1032, the elliptic laser light 1102 is further shaped into a flat, band-like laser beam 1102a. Thus, the laser light 1102 is formed into a band-like laser beam 1102a so that a wider area can be illuminated or detected, compared to the laser light 1102a which is focused as a spot.

For manufacturing semiconductor devices or liquid crystal panel devices, the environment of a clean room or clean booth is an important factor to determine the yield of products. Therefore, a light-scattering particle counter that uses a light scattering property may be used. As an example of this type of particle counter, the light-scattering particle counter 1100 shown in FIGS. 24(a)-24(b) may be used.

In the light-scattering particle counter 1100 shown in FIG. 24(a), laser light 1102 emitted from the light source 1101 such as a laser diode is transmitted through a projection lens system 1103 to be shaped band-like and irradiated onto an air-tight section 1104. With the operation of a suction pump 1105, a sample fluid 1106 is flowed into the airtight section 1104. With such a configuration, when laser light 1102 is irradiated onto the particles (dust) present in the measuring area 1107, scattered light 1108 is generated. Then, the scattered light 1108 enters the light-receiving device 1110 through the light-receiving lens 1109. With this, the number of the voltage pulses obtained by the light-receiving device 1110 is analyzed to count the number of particles.

More specifically described, the projection lens system 1103 of the light-scattering particle counter 1100 consist of a collimating lens 1031 and a cylindrical lens 1032; laser light 1102 is collimated into a parallel beam by the collimating lens 1031 and then changed to a band-like flat beam by the cylindrical lens 1032. With this, the energy density (irradiation light intensity) of the laser light 1102 is increased to raise the sensitivity of the light-scattering particle counter 1100.

Note that a beam pocket 1111 is arranged downstream of the projection lens 1103, by which the laser light 1102 that did not strike particles is trapped. With this, stray light inside the light-scattering particle counter 1100 is reduced so that the background noise entering the light-receiving device 1110 is reduced to improve the signal-to-noise ratio (SNR).

Next, more specifically described, the light-receiving lens 1109 of the light-scattering particle counter 1100 is opposed to the measuring area 1107 and arranged such that the optical axis thereof is perpendicular to the optical axis of the laser light 1102. Describing the configuration of the light-receiving lens 1109 in detail referring to FIG. 24(b), the light-receiving lens 1109 is configured such that two objective lenses are opposed to each other, for example. Because of this, the scattered light 1108 travels on the optical path shown in FIG. 24(b) via the light-receiving lens 1109 and enters the light-receiving device 1110 at a predetermined value of numerical aperture (hereinafter denoted as “NA”), increasing the sensitivity of the light-scattering particle counter 1100.

Thus, in the light-scattering particle counter 1100 shown in FIG. 24(a), the projection lens 1103 and the light-receiving lens 1109 are used to increase the irradiation light intensity and increase the NA; as a result, the sensitivity of the light-scattering particle counter 1100 is increased. The smallest measurable particle size (the size of the smallest particle that can be measured) is about 0.3 μm.

In recent years, greater cleanliness of semiconductor devices has been demanded as the integration of semiconductor devices proceeds, thus requiring stricter environmental conditions of clean rooms and clean booths. For this reason, light-scattering particle counters in recent years are demanded with reduced manufacturing cost, smaller measurable particle size, and further improvement of the sensitivity (for example, several times or more).

[Patent reference 1] Japanese Unexamined Patent Application 2001-74640 (Tokkai)

[Patent reference 2] Japanese Unexamined Patent Application 2005-70027 (Tokkai)

In the above-mentioned particle counter, a data input terminal and a display section for displaying results of computations, etc. are installed in the measuring control section that controls the measuring section; therefore, the entire device is oversized and expensive because of complicated computations such as the computation of particle size distribution. Therefore, within the observation environment, for example, inside a clean room, it is necessary to make observations at a plurality of locations; however, an extremely expensive investment is required in order to place a plurality of devices for observing the particle counters. To avoid such an expensive investment, a single particle counter placed on a cart, etc. is moved around inside the room to measure cleanliness sporadically. Because of this, cleanliness at a plurality of measuring locations cannot be constantly and simultaneously monitored.

Also, according to the above-mentioned measuring method, there is an assumption in the process of converting the counting value into a value per unit volume that “the obtained counting value, even the one obtained at any time during the measurement, is invariable”; consequently, the measuring result may contain great error. In such a case, accuracy of the measuring result is degraded. One may attempt to shorten the measuring time by enhancing the suction of a fluid to be measured; however, this method requires the improvement of the capability of the measuring section to enhance the suction of a fluid to be measured, thus increasing cost of the measuring section.

There are cases in which the cleanliness of a plurality of locations inside a clean room needs to be monitored. In such a case, a particle counting device is moved to each location to measure cleanliness sporadically because the installation of a plurality of expensive particle counting devices at multiple locations increases cost. This makes it difficult to simultaneously monitor a plurality of locations inside a clean room while preventing cost from increasing.

Further, in the above-mentioned particle counter 1100, the light intensity needs to be increased to raise the sensitivity of the particle counter; because the laser light is converted to a band-like laser beam 1102a, the light-receiving lens 1109 uses a lens having a large outside dimension (diameter) so that as much scattered light 1108 from the particles 1120 enters the light-receiving device 1109 as possible. Consequently, the lens ends up having a larger outside dimension (diameter) and a longer focal length, thus increasing the size of the optical system and the size and weight of the particle counter 1100 itself.

However, in the above-mentioned light-scattering particle counter 1100, it is difficult to further increase the sensitivity while reducing the manufacturing cost.

To increase the sensitivity of a light-scattering particle counter, the irradiation light intensity may be increased, for example. As described above, in the light-scattering particle counter 1100 (see FIG. 24), the laser light is converted into a flat, band-like beam by the cylindrical lens 1032 so that the irradiation light intensity is increased; however, it is difficult to further increase the irradiation light intensity with this configuration.

A high energy density Helium-Neon (He—Ne) laser or liquid (dye) laser may be used for the light source 1101 to increase the irradiation light intensity; however, they are expensive, increasing the manufacturing cost. In addition, when a He—Ne laser is used for the light source, for example, a gas laser tube is required, which results in enlargement of the light-scattering particle counter. When a light-scattering particle counter is placed at the front end of an arm robot used for transporting semiconductor wafers and the number of airborne particles inside a cassette is measured when the robot loads works in the cassette, a fairly downsized (about the size of a quarter or 500 yen coin) light-scattering particle counter needs to be used; however, when the above-mentioned expensive laser is used for the light source, such demand cannot be satisfied.

To increase the sensitivity of a light-scattering particle counter in another way, the NA for collecting light may be increased. As described above, in the light-scattering particle counter 1100, the NA is increased by using a light-receiving lens 1109 consisting of two objective lenses; however, it is difficult to further increase the NA with this configuration. More specifically, as the radius of the lens 1109 shown in FIG. 24(b) is increased to have more scattered light 1108 enter the light-receiving lens 1109 in order to increase the NA, the angle of incidence of the light also changes: when the angle of incidence at which the scattering light 1108 enters the light-receiving lens reaches the critical value, a total reflection occurs and prevents the light from passing through. Therefore, the NA cannot be further increased by simply increasing the radius of the light-receiving lens 1109.

To increase the sensitivity of the light-scattering particle counter in another way, the wavelength of the laser light emitted from the light source may be shortened or a highly sensitive light-receiving device may be used; however, if a blue diode having a short wavelength is used for the light source or a light-scattering particle counter using a highly sensitive light-receiving device such as an ultraviolet ray light-receiving device is used, the manufacturing cost is increased.

Then, at least an embodiment of the present invention provides a particle counter capable of constant monitoring or observation and a particle counting device equipped with it.

At least an embodiment of the present invention provides a particle counting system capable of shortening the measuring time relatively inexpensively while maintaining accuracy of the measuring results and its use method.

At least an embodiment of the present invention provides a particle counter that can be downsized.

At least an embodiment of the present invention provide a particle counter that can increase the sensitivity while reducing the manufacturing cost, and can contribute to downsizing.

### SUMMARY OF THE INVENTION

To achieve the above objectives, at least an embodiment of the present invention is a particle counter for detecting and counting particles in a fluid to be measured, comprising a measuring section for detecting the particles, and a control section for processing the output signal from the measuring section; wherein a signal to issue a warning is generated when an abnormality occurs.

According to at least an embodiment of the present invention, a constant monitoring or observation is possible, and when an abnormality occurs, a signal to issue a warning is output to a device such as an alarm, etc. to issue a warning.

Also, it is preferred that the measuring section have a photo detector for optically detecting the particles, that the control section have a counter section for counting particles based on the output from the photo detector, a mode switching section capable of switching from a counting mode of the counter section to a mode selected from pre-set modes, and a parameter storage section capable of storing the warning level, i.e., the particle counting value at which a warning set corresponding to the counting mode is issued, and that when the particle counting value exceeds the warning level, a signal to issue a warning be generated. Note that the “counting mode” means a method of counting particles or a method of counting process particles. Also, “the warning level, i.e., the particle counting value at which a warning should be issued” includes parameters such as a sampling time, threshold value, etc. set in the parameter setting section.

According to at least an embodiment of the present invention, the particle counter can switch among a plurality of modes; therefore, it can be applied to various uses.

Further, the particle counting device of the at least an embodiment of present invention comprises a particle counter which has a measuring section for detecting particles in a fluid to be measured and a control section for processing the output signal from the measuring section and is permanently or constantly placed in a necessary observation point to issue a warning when an abnormality occurs in the detection of the particles, and an information processing device capable of communicating with the particle counter for processing the measurement result obtained by the particle counter and displaying its result. According to at least an embodiment of the present invention, a particle counter can be permanently or constantly placed at an observation-necessary location, providing a constant monitoring or observation.

It is preferred that the aforementioned information processing section have a data accumulating section for accumulating the measurement data from the particle counter, and a trend graph display section for graphing and displaying a trend of the measurement data based on the measurement data accumulated in the accumulating section and/or the measurement data from the particle counter.

According to at least an embodiment of the present invention, the data output from the particle counter is accumulated and graphed so that the status of the particles at the observation point can be visually recognized.

It is preferred that the control section of the particle counter be provided with a counter section for counting the number of particles based on the output from the measuring section and a mode switching section capable of switching the setting from a counting mode of the counter section to a mode selected from pre-set modes, and that the trend graph displaying section of the information processing device display the measurement data by a graph corresponding to the counting mode set by the mode switching section. Note that the “counting mode” means a method of counting particles or a method of counting the processing of particles.

According to at least an embodiment of the present invention, the particle counting device is capable of switching among a plurality of modes; therefore, it can be applied to various kinds of uses.

It is also preferred that at least one of the following measuring deices such as a wind velocity measuring device, a temperature measuring device, a humidity measuring device, an illumination measuring device, other environmental measuring devices and a process status data input device be provided to communicate with the information processing device.

According to at least an embodiment of the present invention, the observation data can be obtained from a measuring device other than the particle counter.

It is further preferred that the communication between the particle counter and the information processing device can be switched between a constant connection and an intermittent connection.

According to at least an embodiment of the present invention, the particle counting device can be operated as a single machine separated from the information processing device.

In order to achieve the above objectives, at least an embodiment of the present invention provides the following:

(1) A particle counting system comprising a plurality of particle counters for detecting and counting particles in a fluid to be measured, and an information processing device for processing the counting results obtained from the plurality of particle counters; wherein the plurality of particle counters are electrically connected to the information processing device in multiple and in parallel.

At least an embodiment of present invention comprises a plurality of particle counters and an information processing device for processing the counting results obtained from the plurality of counters; and the plurality of particle counters are electrically connected to the information processing device in multiple and in parallel; therefore, a plurality of particle counters are arranged in multiple and in parallel and the counting results obtained from the plurality of particle counters can be processed collectively at the information processing device.

Therefore, when ten particle counters, for example, are connected to the information processing device in multiple and in parallel, the suction of a fluid to be measured by the entire particle counting system is 10 times stronger compared to that by one particle counter, thus shortening the measuring time to one tenth. Also, the particle counter of at least an embodiment of the present invention, different from a conventional particle counter, has only a measuring section as a major configuration component. Therefore, even when a plurality of particle counters are used in a particle counting system, the increase of cost can be minimal.

Particularly, a conventional particle counter is configured, as described above, such that the measuring section and the measuring result display section are integrated; therefore, it is unrealistic from the viewpoint of cost performance to use such a particle counter in plural. Also, since a conventional particle counter is normally as large as a DVD player, the large size has made it unrealistic to be used in plural (it is inconvenient to carry around several machines). However, according to the particle counting system of at least an embodiment of the present invention, a particle counter in use is an inexpensive and small device whose main configuration component is only the measuring section. By using this particle counter in plural, the increase of cost can be minimal while shortening the measuring time.

The process of converting the counting values obtained in the particle counters into unit volume is also not particularly necessary (this does not mean to exclude this process); without conversion, the measurement results do not contain large errors, thus preventing deterioration in the accuracy of the measurement results. Further, because a plurality of particle counters are used, even when one of the counters becomes out of order, the measurement of particles can be continued by the other particle counters.

(2) A particle counting system comprising a plurality of particle counters for detecting and counting particles in a fluid to be measured, wherein to one of the plurality of particle counters, the other particle counters are electrically connected in multiple and in parallel.

According to at least an embodiment of the present invention, a plurality of particle counters are equipped, and to one of the plurality of particle counters, the other particle counters are electrically connected in multiple and in parallel; therefore, a plurality of particle counters can be arranged in multiple and in parallel and the counting results obtained from those particle counters can be collectively processed by one particle counter.

Therefore, the increase of cost can be minimal while shortening the measuring time in the same manner as the above-mentioned particle counting system. Deterioration in the accuracy of the measurement results can also be prevented. In particular, in the particle counting system of at least an embodiment of the present invention, there is no need to provide an information processing device for processing the counting results obtained from the plurality of particle counters; therefore, the overall system can be made smaller.

(3) The particle counting system described in (1) wherein the information processing device has a counting result processing means for processing every counting result, and when the plurality of particle counters are operated in multiple and in parallel, the counting results from the plurality of particle counters are collected at the counting result processing means.

According to at least an embodiment of the present invention, the aforementioned information processing device is provided with a counting result processing means for processing every counting result, and when the plurality of particle counters are operated in multiple and parallel, the counting results from the plurality of particle counters are collected at the counting result processing means; therefore, the increase of cost can be kept to a minimum while shortening the measuring time, and deterioration in the accuracy of the measurement results can be prevented.

(4) The particle counting system described in (2) wherein the said one particle counter is provided with a counting result processing means for processing every counting result, and when the plurality of particle counters are operated in multiple and in parallel, the counting results from a plurality of said particle counters are collected at the counting result processing means.

According to at least an embodiment of the present invention, the aforementioned one particle counter is provided with a counting result processing means for processing every counting result, and when the plurality of particle counters are operated in multiple and parallel, the counting results from the plurality of particle counters are collected at the counting result processing means; therefore, the increase of cost can be kept to a minimum while shortening the measuring time, and deterioration in the accuracy of the measurement results can be prevented.

(5) The particle counting system described in (3) or (4) wherein the counting result processing means adds up the collected counting results.

According to at least an embodiment of the present invention, the aforementioned counting result processing means adds up the collected counting results; therefore, a fluid to be measured per unit volume can be measured in a short period of time. In other words, ten particle counters, for example, are connected in multiple and parallel and every counting value obtained by each of the particle counters is added up so that the measuring time of a fluid to be measured per unit volume can be shortened to one tenth.

(6) The particle counting system described in any of (1) through (5) wherein to each of the particle counters is connected a suction means for sucking a fluid to be measured; for detecting and counting particles in a fluid to be measured in a specific monitoring area, the plurality of suction means are arranged in the specified monitoring area.

According to at least an embodiment of the present invention, to each of the particle counters is connected a suction means for sucking a fluid to be measured; for detecting and counting particles in a fluid to be measured in a specific monitoring area, the plurality of suction means are arranged in the specific monitoring area; therefore, the time needed to suck the fluid to be measured in the specific monitoring area up to a unit volume can be shortened.

(7) A use method of a particle counting system which comprises a plurality of particle counters for detecting and counting particles in a fluid to be measured and an information processing device for processing counting results obtained from the plurality of particle counters and in which the plurality of particle counters are electrically connected to the information processing device in multiple and in parallel, wherein the plurality of particle counters are operated in multiple and in parallel.

(8) A use method of a particle counting system which comprises a plurality of particle counters for detecting and counting particles in a fluid to be measured and in which to one of the plurality of particle counters the other particle counters are electrically connected in multiple and in parallel, wherein the plurality of particle counters are operated in multiple and in parallel.

According to at least an embodiment of the present invention, in a use method of a particle counting system comprising a plurality of particle counters and an information processing device or a use method of a particle counting system having a plurality of particle counters, the plurality of particle counters are operated in multiple and in parallel as described above; therefore, the increase of cost can be kept to a minimum while shortening the measuring time, and deterioration in the accuracy of the measurement results can be prevented.

At least an embodiment of the present invention comprises a light source for emitting laser light, a projection lens system for condensing the laser light onto a sample fluid, a light-receiving lens system for condensing the scattered light generated as particles in the sample fluid are irradiated with the laser light, and a photo detector for detecting the condensed scattered light; wherein the light-receiving lens system is configured by two lenses having a numerical aperture (NA) of 0.45 or larger.

According to at least an embodiment of the present invention, the intensity of laser light emitted from the light source can be efficiently used to increase the SN ratio.

It is also preferred in at least an embodiment of the present invention that the light-receiving lens system be made of resin. In this way, the particle counter can be made lighter in weight. Also, productivity can be increased inexpensively.

It is further preferred in at least an embodiment of the present invention that the projection lens system have a condenser lens for condensing the laser light onto the sample fluid and the condenser lens be identical with lenses configuring the light-receiving lens system. Note that the “identical” means that the condenser lens and the lenses configuring the light-receiving lens system share the same design specifications.

According to at least an embodiment of the present invention, the two lenses configuring the light-receiving lens system are the same as the condenser lens; therefore, common components can be used, facilitating quality control. Also, the production cost of particle counter can be reduced.

It is also preferred in at least an embodiment of the present invention that the condenser lens be made of resin. According to at least an embodiment of the present invention, the particle counter can be made lighter in weight. Also, productivity can be increased inexpensively.

It is further preferred in at least an embodiment of the present invention that the light source be a laser diode having a wavelength of 800 nm or less and the light-receiving lens system and the condenser lens be designed to have a wavelength of 800 nm or less. According to at least an embodiment of the present invention, a relatively low-priced photo detector can be used. Further, for detecting the particle size of 0.05 μm to 0.3 μm or less, a wavelength of the light source to which Rayleigh Scattering Method can be applied can be selected.

It is also preferred in at least an embodiment of the present invention that the polarizing or deflecting direction of the laser beam be perpendicular to the plane including the optical axis of the laser diode and the direction in which the scattering light is incident on the photo detector.

According to at least an embodiment of the present invention, the light intensity of the light scattered in the direction in which the photo detector detects can be increased, thus providing the high sensitivity.

It is preferred that the laser beam be formed as a band-like laser beam which is wider than the size of the sample fluid and [the sample fluid] flows across the traveling direction of the band-like laser beam at a right angle, and in the wider direction of the band-like laser beam, the band-like laser beam travel across the entire width of the sample fluid.

According to at least an embodiment of the present invention, laser light is formed as a band-like laser beam; therefore, a wider area can be detected compared to using a laser beam condensed as a spot. Therefore, more sample fluid per unit time can be transmitted.

In order to achieve the above objectives, at least an embodiment of the present invention provides the following:

(1) A particle counter which irradiates a measuring area with laser light emitted from a light source and counts particles present in the measuring area based on the scattered light generated by the particles, wherein a pair of lenses are arranged via the measuring area, each of the lenses of the pair respectively having a convex-curved surface on the side near the measuring area and a flat surface on the side far from the measuring area, a light-transmitting fluid path in which the particles flow is provided between the pair of lenses, and a reflective member for reflecting laser light is provided on the flat surface of one lens of the pair arranged far or opposite from the light source.

According to at least an embodiment of the present invention (1), in a particle counter that has a measuring area which is irradiated by laser light and counts particles in the measuring area, as described above, a pair of lenses are arranged via the measuring area, each lens in the pair respectively having a convex-curved surface on the side near the measuring area and a flat surface on the side far from the measuring area, and a reflective member for reflecting laser light is provided on the flat surface of the lens arranged on the side far or opposite from the light source; therefore, the laser light that has irradiated to the measuring area but did not strike the particles is transmitted through the one lens of the pair arranged far or opposite from the light source, is reflected from the above-mentioned reflective member and then returned to the measuring area again.

Therefore, the particles are irradiated first by the laser light which is emitted from the light source toward the measuring area and then by the returning light that has passed through the measuring area once, been reflected from the reflective member and returned to the measuring area; thus, the irradiation light intensity in the measuring area is increased about 2 times stronger (if the reflective ratio is considered, it is less than 2 times), resulting in the increased sensitivity of the particle counter.

(1A) A particle counter which irradiates a measuring area with laser light emitted from a light source and counts particles present in the measuring area based on the scattered light generated by the particles, comprising a pair of lenses arranged via the measuring area, wherein each lens of the pair respectively has a convex- or concave-curved surface on the side near the measuring area and a flat surface on the side far from the measuring area, and a light-transmitting fluid path in which the particles flows is provided between the pair of lenses, and a reflective member for reflecting laser light is provided on the flat surface of the lens arranged far or opposite from the light source.

According to at least an embodiment of the present invention, in a particle counter that has a measuring area which is irradiated by laser light and counts particles in the measuring area, as described above, a pair of lenses are arranged via the measuring area, each lens of the pair respectively having a convex- or concave-curved surface on the side near the measuring area and a flat surface on the side far from the measuring area. Also, a light-transmitting fluid path, in which particles flow, is arranged between the pair of lenses, and a reflective member for reflecting laser light is provided on the flat surface of the lens of the pair arranged far or opposite from the light source; therefore, the laser light that has been irradiated onto the measuring area but did not strike the particles flowing in the light-transmitting fluid path is transmitted through the one lens of the pair arranged far or opposite from the light source, is reflected from the above-mentioned reflective member, and then returned to the measuring area again.

Therefore, the particles flowing in the light-transmitting fluid path are irradiated first by the laser light which is emitted from the light source toward the measuring area and then by the returning light that has passed through the measuring area once, been reflected from the reflective member and returned to the measuring area; thus, the irradiation light intensity in the measuring area is increased about 2 times stronger (if the reflective ratio is considered, it is less than 2 times), resulting in the increased sensitivity of the particle counter.

In a particle counter for detecting and counting particles in a fluid to be measured, at least an embodiment of the present invention comprises a measuring section for detecting the particles and a control section for processing the output signal from the measuring section, wherein when an abnormality occurs, a signal to issue a warning is generated; therefore, constant monitoring or observation is possible, and when an abnormality occurs, a signal to issue a waning can be output to a device such as an alarm.

Further, a particle counting device of at least an embodiment of the present invention comprises a particle counter equipped with a measuring section for detecting particles in a fluid to be measured and a control section for processing output signals from the measuring section, and permanently or constantly placed at a observation-necessary location so that when an abnormality occurs in the detection of the particles, a signal to issue a warning can be generated, and an information processing device which is capable of communicating with the particle counter and which processes the measuring data from the particle counter and displays the results.

According to at least an embodiment of the present invention, the particle counter can be permanently or constantly placed at an observation-necessary location for constant monitoring or observation.

As described above, according to at least an embodiment of the present invention, suction of a fluid to be measured per unit volume can be performed in a shorter period of time at less cost than a conventional particle counter, resulting in a shorter measuring time. Accuracy of the measuring results can also be prevented from being degraded. Further, because a plurality of particle counting devices are used, even when one of the particle counting devices becomes out of order, the particle measurement can be continued by the other particle counting devices.

At least an embodiment of present invention comprises a light source for emitting laser light, a projection lens system for condensing the laser light onto a sample fluid, a light-receiving lens system for condensing scattered light generated by irradiating the particles in the sample fluid with the laser light, and a photo detector for detecting the condensed scattered light; wherein the light-receiving lens system is configured by two lenses having a numerical aperture (NA) of 0.45 or larger. Therefore, the intensity of laser light irradiated from the light source can be efficiently used to increase the S/N ratio.

As described above, according to at least an embodiment of the present invention, the irradiation light intensity in the measuring area can be increased about 2 times stronger, a high NA can be realized even when a normal light-receiving device is used, and the sensitivity of the particle counter can be increased. Also, since the sensitivity can be increased without using expensive, large light source and light-receiving device, higher manufacturing cost and larger size of the particle counter can be prevented.

### BRIEF DESCRIPTION OF DRAWING

Embodiments will now be described, by way of example only, with reference to the accompanying drawings which are meant to be exemplary, not limiting, and wherein like elements are numbered alike in several Figures, in which:

FIG. 1 is a block diagram showing a particle counter of at least an embodiment of the present invention and a particle counting device equipped with it.

FIG. 2 is an explanatory diagram showing the operation of a particle detecting mode in the embodiment.

FIG. 3 is an explanatory diagram showing the operation of a first particle counting mode in the embodiment.

FIG. 4 is an explanatory diagram showing the operation of a second particle counting mode in the embodiment.

FIG. 5 is an explanatory diagram showing the operation of a particle monitoring mode in the embodiment.

FIG. 6 is a block diagram showing a configuration of a particle counting system of at least an embodiment of the present invention.

FIG. 7 is a flowchart to explain the system operation of the particle counting system of at least an embodiment of the present invention.

FIG. 8 is a diagram to explain a construction example of the particle counting system of at least an embodiment of the present invention.

FIG. 9 is a diagram to explain a construction example of the particle counting system of at least another embodiment of the present invention.

FIGS. 10(A) and 10(B) are respectively a plan view and a side view of the particle counter of at least an embodiment of the present invention.

FIG. 11 is a cross-sectional view of a light-receiving lens system applied in the particle counter of at least an embodiment of the present invention.

FIG. 12 is a cross-sectional view of another light-receiving lens system applied in the particle counter of at least an embodiment of the present invention.

FIG. 13 is a perspective view of a mechanical structure of the particle counter of the embodiment of at least an embodiment of the present invention.

FIG. 14 is a side view of the particle counter shown in FIG. 13.

FIGS. 15(a) through 15(d) are explanatory diagrams to show how the scattered light is condensed onto a light-receiving surface of a photo detector in the particle counter shown in FIG. 13.

FIGS. 16(a) and 16(b) are explanatory diagrams showing a mechanical configuration of a light-scattering particle counter equipped with a plurality of pairs of cylinder lenses.

FIGS. 17(a) and 17(b) are explanatory diagrams to show how the scattered light is condensed onto a light-receiving surface of a photo detector in the light-scattering particle counter of at least another embodiment of the present invention.

FIG. 18 is a perspective view of a mechanical structure of the particle counter of at least an embodiment of the embodiment of the present invention.

FIGS. 19(a) and 19(b) are side views of the light-scattering particle counter shown in FIG. 18.

FIGS. 20(a) through 20(d) are explanatory diagrams to show how the scattered light is condensed onto a light-receiving surface of a photo detector in the light-scattering particle counter shown in FIG. 18.

FIG. 21 is a diagram showing a mechanical configuration of a light-scattering particle counter equipped with a plurality of pairs of cylinder lenses.

FIGS. 22(a) and 22(b) are explanatory diagrams to show how the scattered light is condensed onto a light-receiving surface of a photo detector in the light-scattering particle counter of at least another embodiment of the present invention.

FIG. 23 is a perspective view of a conventional particle counter.

FIGS. 24(a) and 24(b) are diagrams showing a conventional light-scattering particle counter.

### DETAILED DESCRIPTION OF PREFERRED EMBODIMENTS

The configuration of at least an embodiment of the present invention is described hereinafter based on the best form of an embodiment shown in the figures.

### First Embodiment

### (Overall Configuration)

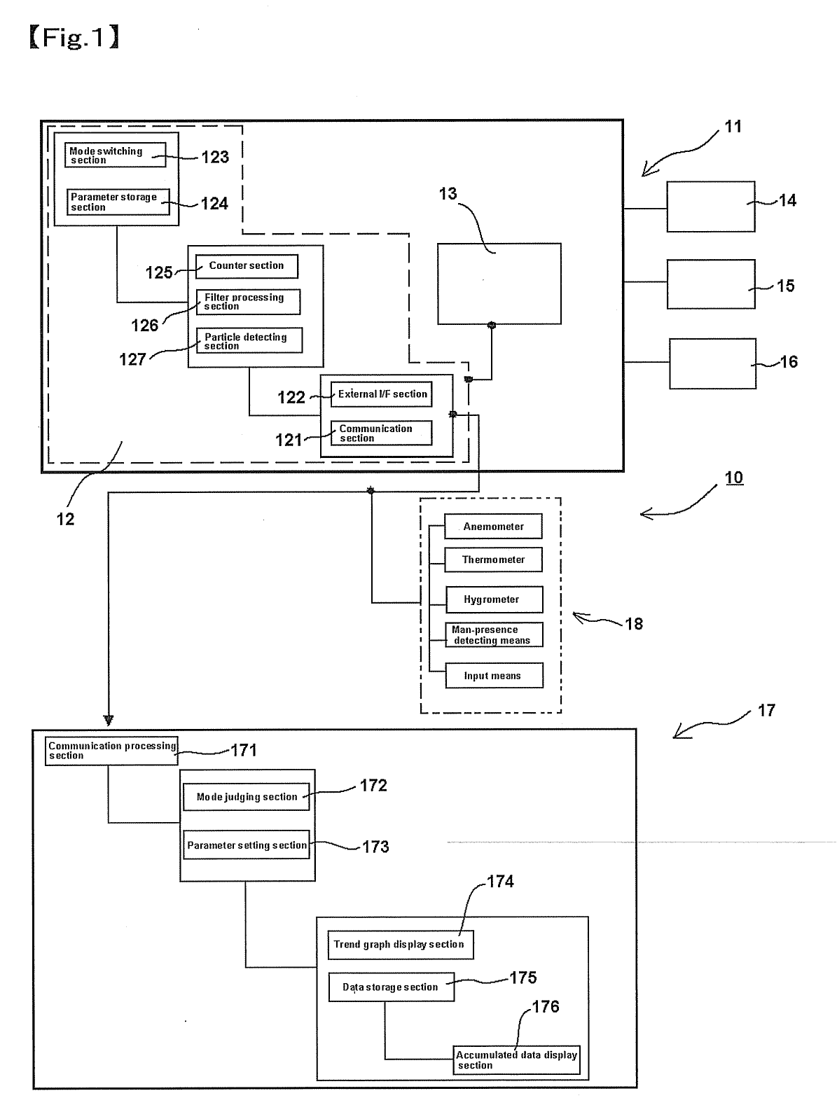

FIG. 1 is a block diagram showing a particle counter of at least an embodiment of the present invention and a particle counting device equipped with it. Note that, more specifically, it is a block diagram of a particle counting device equipped with a measuring device.

A particle counting device 10 is configured mainly by a particle counter 11 that can be permanently placed at an observation-necessary point, an information processing device 17 connected to the particle counter 11 for generating measuring data and displaying and processing the detection data, and other measuring devices, other than the particle counter, for measuring wind velocity, temperature, humidity, etc. Note that the observation-necessary location may be single or plural.

### (Configuration of Particle Counter)

The particle counter 11 is a device for detecting and counting particles in a fluid to be measured, which comprises a measuring section 13 for detecting particles and a control section 12 for controlling the entire device and performing predetermined processing based on the output signals from the measuring section 13 (see the dotted line inside the particle counter 11). As shown in FIG. 1, the control section 12 is configured by a communication section 121, an external I/F section 122, a measuring mode switching section 123, a parameter storage section 124, a counter section 125, a filter processing section 126, and a particle detecting section 127. Also, although not illustrated, the measuring section 13 has an optical system for optically detecting particles and a fluid path means in which a sample fluid flows. Laser light emitted from a light source such as a laser diode is transmitted through a projection lens and projected as a band-like beam. By the operation of a suction pump 15, the sample fluid is flowed.

Further, a power source device 14 for supplying power, the suction pump 15 as the fluid path means and an alarm 16 for notifying an observer by issuing a warning such as flashing lights or noise are connected to the particle counter 11.

The communication section 121 configuring the control section 12 sends the observation (detection) data to the information processing device 17 (personal computer, for example) or a PLC circuit (power line communications circuit) that can perform communications by using a power line. When the observation/detection data exceeds a predetermined level value, a predetermined signal is output to the alarm 16, etc. to issue a warning to an observer. Note that in this embodiment the communication section 121 performs only a real-time processing, and thus does not have a memory function for storing the old data so that the device can be made smaller and lighter in weight.

The external I/F section 122 is equipped with a digital I/O and an asynchronous serial communication (RS232) through which the particle counter can be connected to a host computer, a PLC circuit, and the alarm 16.

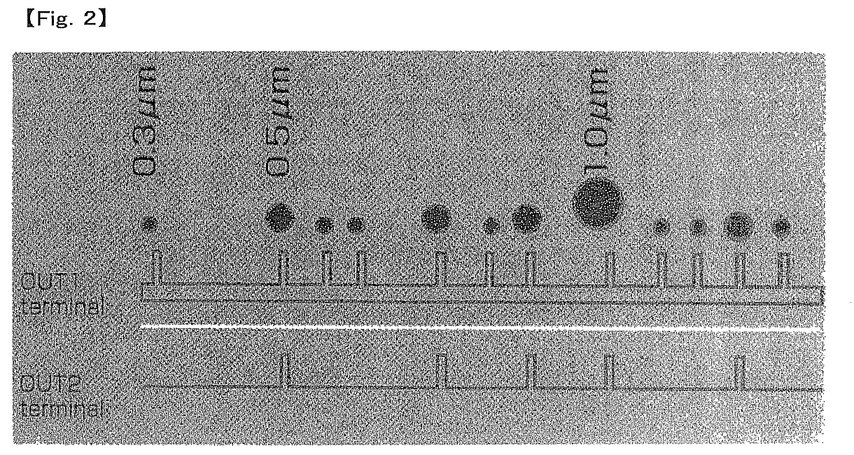

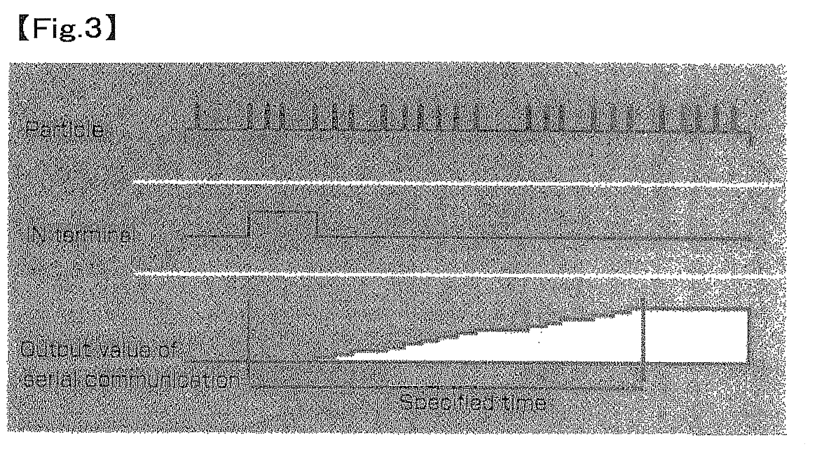

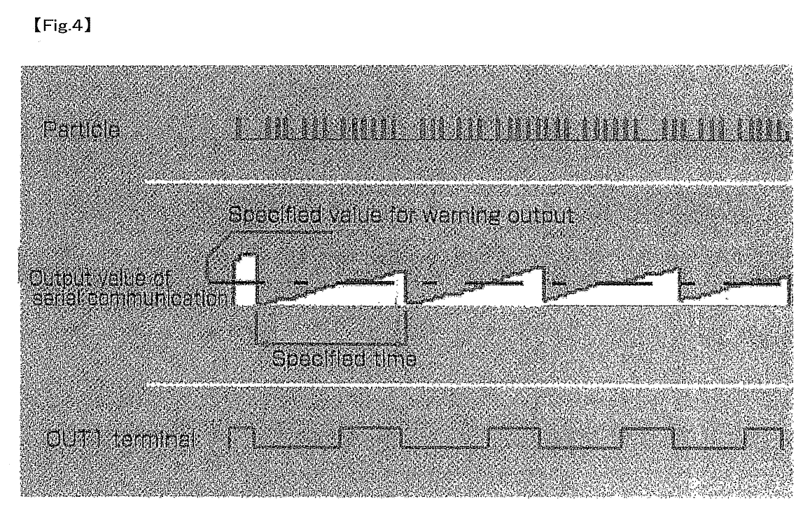

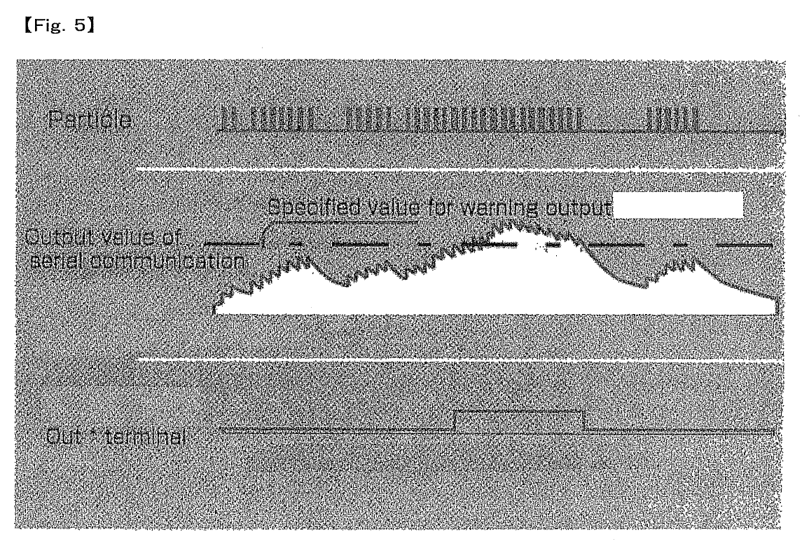

The measuring mode switching section 123 selectively switches among pre-set particle counting modes with a switch (not illustrated). In this embodiment, four measuring modes are set and they are a particle detecting mode, a first particle counting mode, a second particle counting mode and a particle monitoring mode. These four measuring modes are described referring to FIG. 2 through FIG. 5. FIG. 2 is an explanatory diagram showing the operation of the particle detecting mode. FIG. 3 is an explanatory diagram showing the operation of the first particle counting mode. FIG. 4 is an explanatory diagram showing the operation of the second particle counting mode. FIG. 5 is an explanatory diagram showing the operation of the particle monitoring mode.

In the particle detecting mode, a pulse is output every time the particle is detected at the measuring section 13. With this, an operator can be called to an attention by a warning lamp, or when the particle counter is connected to the information processing device 17 or a PLC, a contamination status can be displayed on a centralized operating panel (not illustrated) (see FIG. 2).

In the first particle counting mode, the detected particles are counted and the counting result is sent to the information processing device 17, etc. via the serial communication. In this mode, the counting starts as the input terminal is turned from OFF to ON and ends automatically after a predetermined, specified period of time has passed (see FIG. 3).

In the second particle counting mode, the counting of the detected particles is performed in such a way that the counting is segmented and output by every predetermined, specified period of time, and this is repeated predetermined number of times, the counting values are output through the serial communication, and the output is turned ON at the point when the counting value exceeds a predetermined threshold value (specified value) (see FIG. 4).

In the particle monitoring mode, the counting value of the particles is smoothed by a digital filter and the digital value is output through the serial communication. In the same manner as the above-mentioned second particle counting mode, when the value exceeds a predetermined threshold value (specified value), a warning is output by an output terminal via the alarm 16 (see FIG. 5). Note that the measuring mode is not limited to the said four modes, but is designed to meet observers' needs.

The parameter storage section 124 stores a threshold value at which a warning is issued, and other parameters. The counter section 125 counts the particles detected by the measuring section 13. The filter processing section 126 presumes the density of the particles from the number of the detected particles. The particle detecting section 127 detects the particles by a photo detector such as a light-receiving device.

The measuring section 13 has an optical system for optically detecting particles; in this embodiment, a light-scattering method is used in which particles in a fluid to be measured are detected and counted by using a light-scattering property. The optical system used here includes a laser diode for emitting laser light, a projection lens system for condensing the laser light onto a sample fluid, a light-receiving lens system for condensing the scattered light generated by irradiating the particles in the sample fluid with the laser light, and a photo detector for detecting the condensed scattered light so that the measuring area is irradiated by the laser light and particles present in the measuring area are counted based on the scattered light generated by the particles.

### (Configuration of Information Processing Device)

The information processing device 17 is capable of communicating with the particle counter 11. More specifically described, the information processing device is connected to the particle counter 11 and functions as a terminal section at which necessary data is input; further, during the operation of the particle counter 11, the information processing device displays the output signals sent from the particle counter 11 by time series and functions for visible monitoring. Note that in this embodiment the information processing device 17 is a PC (personal computer). Also the communication method may be by wire or wireless.

In this embodiment, the information processing device 17 includes a communication processing section 171, a mode judging section 172, a parameter setting section 173, a trend graph display section 174, a data accumulating section 175 and an accumulated data display section 176.

The communication processing section 171 communicates with the particle counting device 11 for data transmission. The mode judging section 172 determines which mode is selected from a plurality of modes which is changed by the switch in the particle counting device 11. The parameter setting section 173 sets parameters such as sampling time, threshold value, etc.

The trend graph display section 174 displays sampling data according to the display mode such as the counting mode for counting the particles and the monitoring mode for monitoring the counting of the particles. The data accumulating section 175 saves the data sent by the particle counter 11 as a log file. The accumulated data display section 176 displays the saved log file.

### (Measuring Devices)

In the particle counting device 10 equipped with the measuring devices, not only the particle counter 11 and the information processing device 17 but also the measuring devices 18 for measuring the changes in the environmental conditions are connected in parallel. The measuring device 18 includes an anemometer, a thermometer, a hygrometer, etc.; a man-presence detecting means such as a camera may also be arranged for detecting an operator or the movement of the operator. Also, an input means shown in FIG. 1 is the data of the operation process saved in memory in the information processing device 17; the process may be monitored while compared to the saved data. Note that the measuring devices 18 are not limited to these.

The operation of the particle counter 11 is described next.

The initialized particle counter 11 is connected to the information processing device 17. The data of the necessary measuring mode is sent to the communication section 121 of the particle counter 11 from the information processing device 17 and saved in a predetermined memory. A predetermined threshold value and other parameters are sent to and saved in the parameter storage section 124 to issue a warning.

After the data necessary to operate the particle counter 11 is saved, the particle counter 11 is disconnected from the information processing device 17. The particle counter 11 with a memory setting is permanently or fixedly installed at a necessary observation location as a single unit. Further, to each particle counter 11, an alarm such as a flashing lamp, buzzer, etc. is connected so as to issue a warning when cleanliness of the room is deteriorated. When the number of the particles exceeds the threshold value saved in the parameter storage section 124 as a result of the measurement of the measuring section 13 of the particle counter 11, an alarm such as a flashing lamp is activated so that an operator or observer can visually recognize the status.

More specifically described, in the above-mentioned configuration, when laser light strikes particles in a sample fluid flowed by the suction pump 15, scattered light is generated. The scattered light enters the light-receiving device through the light-receiving lens. Consequently, by analyzing the number of the voltage pulses obtained from the light-receiving device, the number of the particles is obtained or measured and accordingly an operator is called to attention by an alarm lamp, etc. or the data of the particle-containing status is sent to the information processing device 17 or the PLC circuit.

The information processing device 17 for processing the counting results obtained from the particle counter 11 is communicably connected to the particle counter 11 via the communication processing section 171, and includes the communication processing section 171, the mode judging section 172, the parameter setting section 173, the trend graph display section 174, the data accumulating section 175 and the accumulated data display section 176.

The communication processing section 171 communicates with the particle counter 11. The mode judging section 172 determines which mode is selected among a plurality of modes which are changed by the switch in the particle counter 11. The parameter setting section 173 sets parameters such as sampling time, threshold value, etc. The trend graph display section 174 displays sampling data according to the display mode such as the counting mode for counting the particles and the monitoring mode for monitoring the counting of the particle, etc. The data accumulating section 175 saves the observation/detection data sent from the particle counter 11 as a log file. The accumulated data display section 176 displays the saved log file.

The particle counter 11 is arranged in the vicinity of a movable unit such as a large machine, for example, to monitor the status of the particles which changes according to the operation of the movable unit. Also, it may be positioned in an operation area of each operator during manual operations so that a warning may be issued when an abnormality occurs. Further, it may be attached to an operating robot so that the generation of the particles following the movement of the robot arm can be monitored.

### (Major Effects of First Embodiment)

The particle counter 11 can be permanently or fixedly positioned at every observation-necessary point to monitor/observe cleanliness continually or intermittently. Further, when an abnormality occurs, a warning can be issued in an almost real time response. With this, the degraded cleanliness of a room will not be overlooked, minimizing the production of inferior products caused by overlooking.

Further, since the particle counter 11 can communicate with the information processing device 17 that processes the measuring data from the particle counter 11 and displays the results, a particle counter 11 can be permanently placed at every observation-necessary point, thus enabling a constant monitoring/observation.

### Second Embodiment

The best form of at least another embodiment of the present invention is described hereinafter referring to the drawings. Note that the same codes are given to the same components as in the above-mentioned first embodiment.

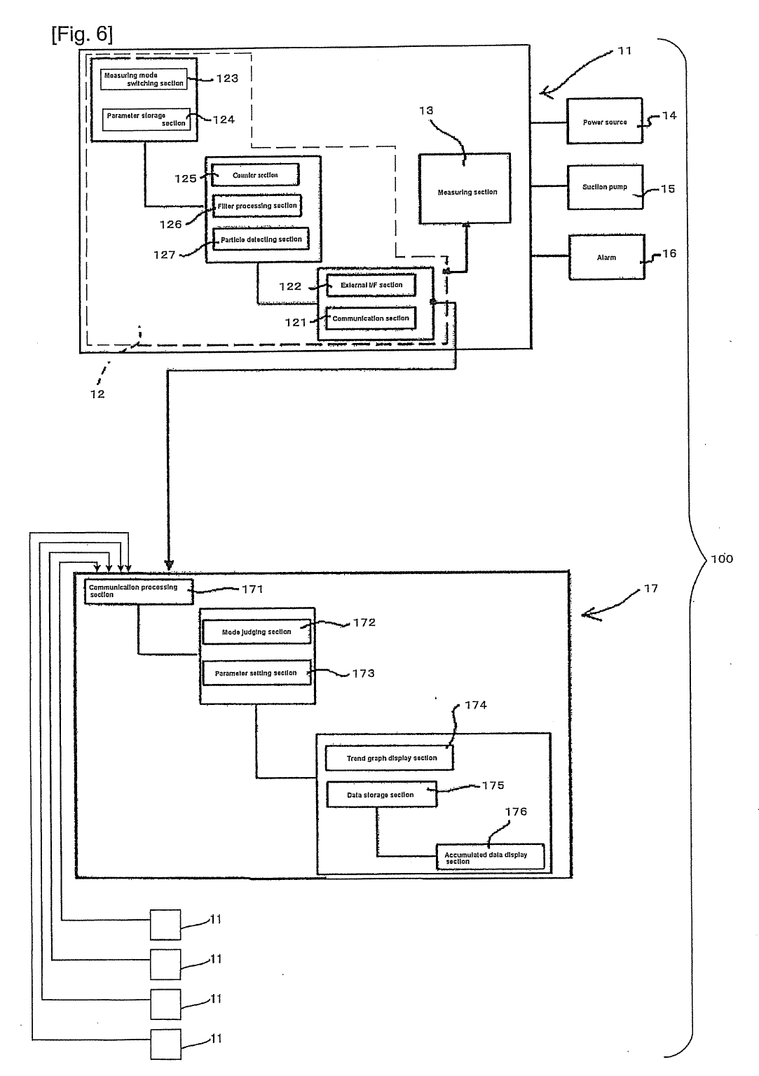

FIG. 6 is a block diagram showing a configuration of a particle counting system 100 of the at least second embodiment of the present invention.

In FIG. 6, the particle counting system 100 has a plurality of particle counters 11, the information processing device 17, the power source device 14, the suction pump 15, and the alarm 16. Note that since the plurality of particle counters 11 share the same configuration, only one of the particle counters 11 is enlarged for explanation. To each of the other particle counters 11 of which the illustration of the internal configuration is omitted, the suction pump 15 (not illustrated) is connected respectively. In the above-mentioned first embodiment, the device having the particle counter 11, the information processing device 17, the power source device 14, the suction pump 15 and the alarm 16 is a fluid measuring device; however, in the second embodiment, a plurality of particle counters 11 are connected to a single information processing device 17.

In the second embodiment having such a configuration, when laser light strikes the particles in a sample fluid flowed by the suction pump 15, scattered light is generated. Then, the scattered light enters the light-receiving device through the light-receiving lens. Finally, by analyzing the number of the voltage pulses obtained from the light-receiving device, the number of the particles is obtained or measured, and accordingly an operator is called to attention by an alarm lamp, etc. or the data on the particle-containing status is sent to the information processing device 17 or the PLC circuit.

The information processing device 17 for processing the counting results obtained from a plurality of particle counters 11 is communicably connected to each of the particle counters 11 via the communication processing section 171, and has the communication processing section 171, the mode judging section 172, the parameter setting section 173, the trend graph display section 174, the data accumulating section 175 and the accumulated data display section 176.

The communication processing section 171 communicates with a plurality of particle counters 11. The mode judging section 172 determines which mode is selected among a plurality of modes which are changed by the switch in the particle counters 11. The parameter setting section 173 sets parameters such as sampling time, threshold value, etc. The trend graph display section 174 displays sampling data according to the display mode such as the counting mode for counting the particles and the monitoring mode for monitoring the counting of the particle, etc. The data accumulating section 175 saves the observation/detection data sent from the particle counter 11 as a log file. The accumulated data display section 176 displays the saved log file.

In the particle counting system 100 shown in FIG. 6, a plurality of particle counters 11 are electrically connected to the information processing device 17 in multiple and in parallel. In other words, in the second embodiment, each of the five particle counters 11 is connected to the communication processing section 171 of the information processing device 17 in parallel in a row. Then, the communication processing section 171 functions as an example of the counting result processing means for processing the counting results obtained from the five particle counters 11, in which the counting results from the five particle counters 11 are collected. Note that the communication processing section 171 may include a CPU or memory.

Therefore, when the particle counting system 100 of this embodiment is used, the entire power of sucking a fluid to be measured is five times more compared to using one particle counter 11; therefore, the measuring time can be shortened to one fifth. As shown in FIG. 6, the particle counter 11 is configured by the measuring section 13 and the control section 12, but not integral with measuring result display section (for example, the trend graph display section 174) which is common to a conventional system; therefore, the cost increase can be minimal.

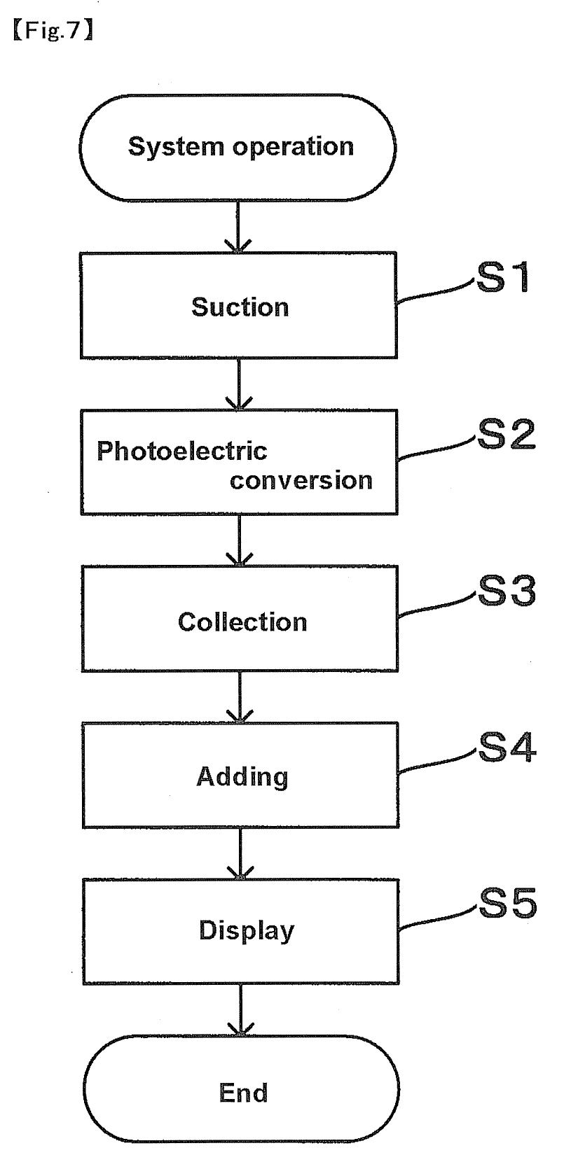

The system operation of the particle counting system 100 of this embodiment is described next. FIG. 7 is a flowchart to explain the system operation of the particle counting system 100 of at least this embodiment of the present invention.

In FIG. 7, suction is first performed (Step S1). More specifically, the suction pump 15, which is connected to the particle counter 11 and sucks the fluid to be measured, is used to suck the fluid to be measured of a unit volume. For example, a suction quantity is 1.0 L/min.

Photoelectric conversion is performed next (Step S2). More specifically, the fluid to be measured sucked by the suction pump 15 is sent to the measuring section 13 of the particle counter 11, and then irradiated with laser light. As the laser light strikes particles present in the fluid to be measured, scattered light is generated. Then, the scattered light enters the light-receiving device through the light-receiving lens. With this, a predetermined voltage pulse is sent to the control section 12 from the measuring section 13.

Collection of the data is performed next (Step S3). More specifically, the control section 12 transmits the observation data/detection data through the communication processing section 121 based on the above-mentioned number of voltage pulses. Since the plurality of particle counters 11 are operated in multiple and in parallel, the observation data/detection data is transmitted from each particle counter 11. Consequently, at the communication processing section 171 of the information processing device 17, all the data transmitted from the particle counters 11 is collected. The suction quantity of each of the particle counters 11 is 1.0 L/min; since five particle counters 11 are used, the total suction quantity is 5.0 L/min. The time required for the suction of a standard volume 1 cf (=28.3 L) for classification is 5.66 min (=340 sec).

Addition is performed next (Step S4). More specifically, the counting value (data) obtained by each particle counter is added up by the CPU in the communication processing section 171. Finally, the data is displayed (Step S5). More specifically, the total value of the counting values (data) obtained from the particle counters 11 is transmitted to the trend graph display section 174 from the communication processing section 171. With this, the sampling data according to each display mode is displayed. In other words, classification is made every 340 seconds.

As described above, when the suction quantity of a conventional particle counter 11 is 1.0 L/min, it takes 28.3 minutes to measure; however, according to the particle counting system 100 of this embodiment, classification can be made in the measuring time of 5.66 minutes. Thus, the measuring time can be shortened. Since the particle counter 11 is used in plural, even when one of them becomes out of order, a longer time may be required for measuring, but the measuring can continue.

Note that although five particle counters 11 are used in the particle counting system 100, the number of the counters 11 is not limited to this. For example, when 28 particle counters 11 are used, the measuring time will be 1 minute to obtain a fluid to be measured of unit volume (28.3 L); when 14 particle counters 11 are used, the measuring time will be 2 minutes to obtain a fluid to be measured of unit volume (28.3 L); when seven particle counters 11 are used, the measuring time will be 4 minutes to obtain a fluid to be measured of unit volume (28.3 L). Although not particularly considered in the particle counting system 100 of this embodiment, a presumption function used in a general particle counter may be added, for example. In other words, in the mode in which the measuring time is prioritized, “30 sec” is selected; the total counting value after 30 seconds is multiplied by 11.34(=340−30) for class (presumption). With this, although the value may include some error, the measuring time can be shortened.

In the particle counting system 100 shown in FIG. 6, the particle counter 11 and the information processing device 17 are individually independent units; however, at least an embodiment of the present invention is not limited to this, but these may be placed in an enclosure to make a single product. In this case, the particle counter has a plurality of suction pumps 15 and the pumps are operated in parallel. Alternately, another method may be used in which a constant capacity aperture (diaphragm) may be added to the particle counter to stabilize the suction quantity so that a suction pump having a large capacity can be shared.

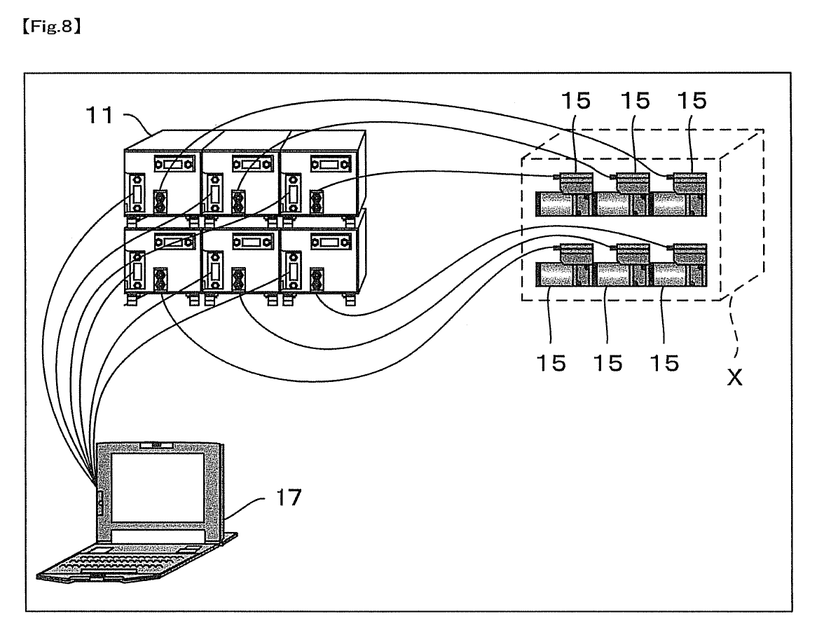

FIG. 8 is a diagram to explain a configuration example of the particle counting system 100 of at least an embodiment of the embodiment of the present invention.

In the particle counting system 100 shown in FIG. 8, the number of the particle counters 11 used are six in total, and to each of the particle counters 11 a suction pump 15 is connected. The dotted-line frame X in FIG. 8 shows a specific monitoring area. For detecting and counting particles present in a fluid to be measured in the specific monitoring area, X, a plurality of suction pumps 15 are placed in the specific monitoring area, X. In this way, the time required to suck the fluid to be measured in the specific monitoring area, X, up to the unit volume can be shortened.

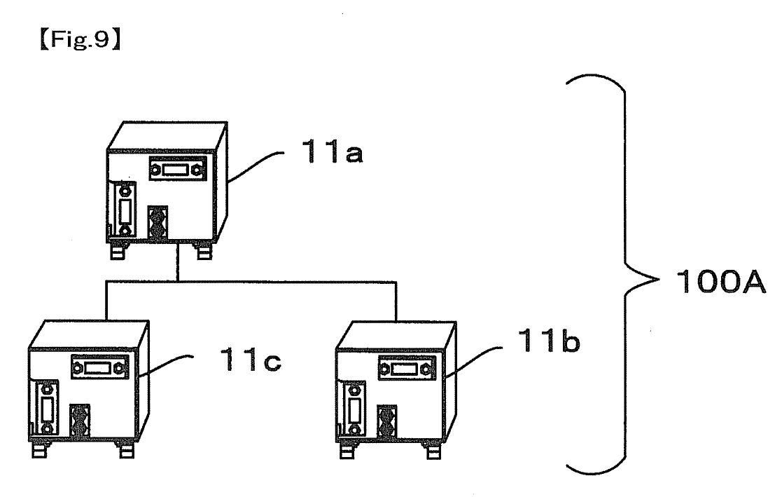

FIG. 9 is a diagram to explain a construction example of a particle counting system 100A of at least another embodiment of the present invention.

As shown in FIG. 9, the particle counting system 100A is configured by three particle counters 11a through 11c for detecting and counting particles present in a fluid to be measured. Note that the power source device 14, the suction pump 15 and the alarm 16 are not illustrated. Also, as shown in FIG. 9, the particle counter 11a is connected to the particle counters 11b and 11c in multiple and in parallel, i.e., a plurality of particle counters are connected in parallel.

It is a feature of the particle counting system 100A that the information processing device 17 is not present. In other words, in the particle counting system 100A, the particle counter 11a is provided with a counting result processing means (such as the CPU in the communication processing section 121) for processing every counting result; when the particle counters 11a through 11c are operated in multiple and in parallel, the counting results from the particle counter 11a through 11c are collected in the counting result processing means. Further, the counting result processing means has a computation function. Therefore, even if no information processing device 17 such as a PC is used, the particle counter 11a functions the same as the information processing device 17, thus shortening the measuring time.

According to the particle counting system and its use method of at least an embodiment of the present invention, a fluid to be measured per unit volume can be sucked in a shorter time inexpensively, compared to a conventional particle counting system, and the measuring time can be shortened.

### Third Embodiment

The configuration of at least an embodiment of the present invention is described in detail hereinafter based on the best form of an embodiment shown in the figures.

### (Overall Configuration)

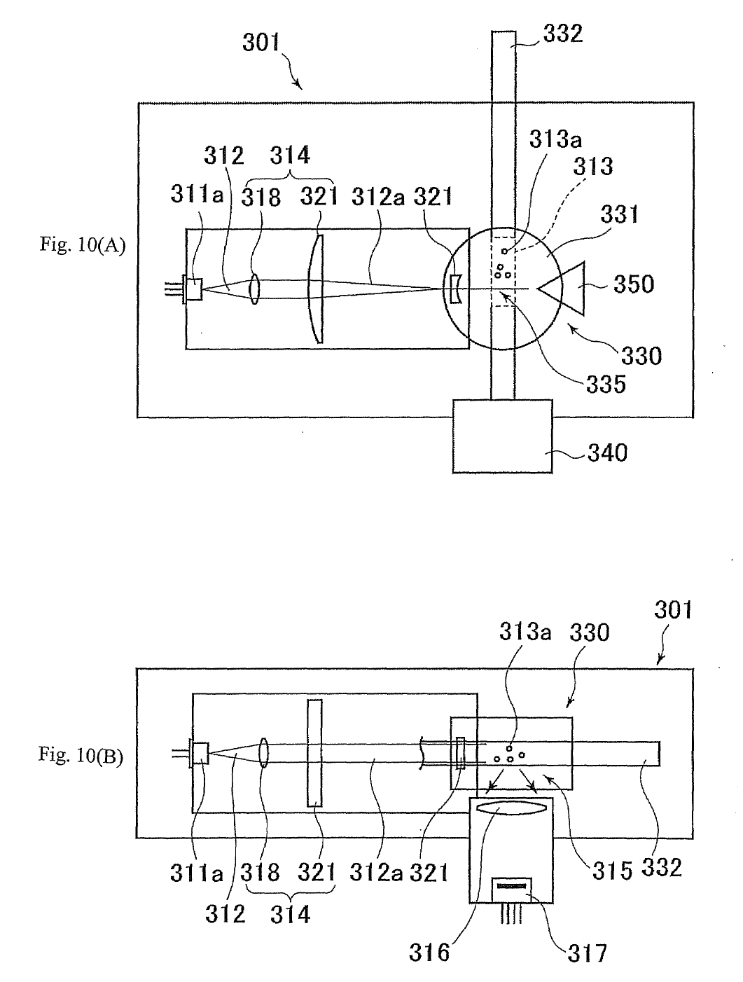

FIG. 10(A) is a plan view of a particle counter of at least an embodiment of the present invention; (B) is its side view. Note that in this embodiment, a particle counter is a light-scattering particle counter that measures the number of airborne particles by using a light scattering property and described hereinafter as “a light-scattering particle counter”.

A light-scattering particle counter 301 is provided with a light source 311 for emitting laser light 312, a projection lens system 314 for condensing the laser light 312 onto a sample fluid 313, a light-receiving lens system 316 for condensing the scattered light 315 generated by irradiating particles 313a present in the sample fluid 313 with the laser light 312, and a photo detector 317 for detecting the condensed scattered light 315; the measuring area 335 is irradiated by the laser light 312 so that the particles 313a are counted based on the scattered light generated by the particles (dust) present in the measuring area 335.

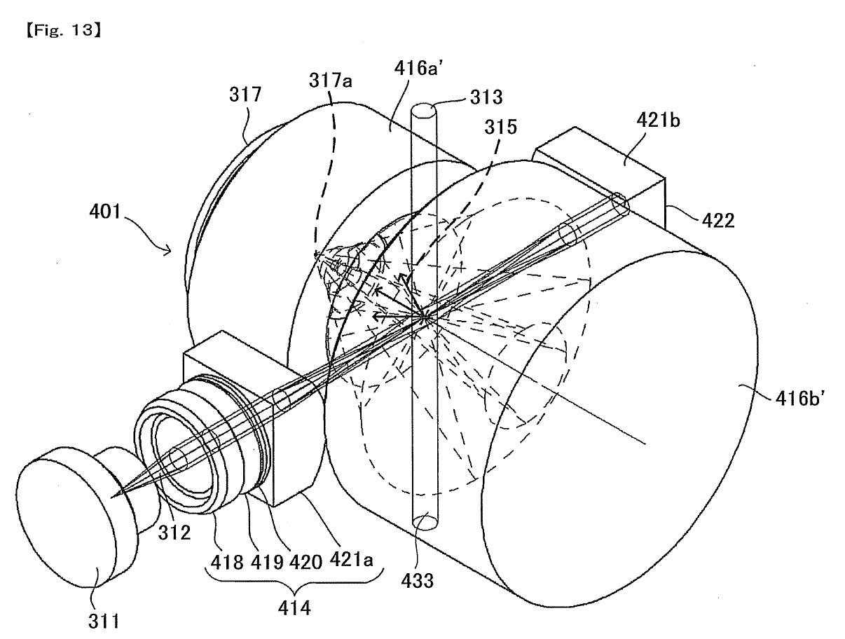

The light source 311 is a laser diode; laser light 312 is emitted from the laser diode 311a in an elliptic shape in the same manner as in a conventional example shown in FIG. 13.

The polarizing direction of the laser diode 311a is perpendicular to the plane (the page in FIG. 10(B)) including the optical axis of the laser diode 311a and the direction in which the scattered light 315 from the particle 313a enters the light-receiving device 317 which is a photo detector. In this way, Rayleigh Scattering Method can be applied to increase the intensity of the light scattered in the direction of the light-receiving device 317.

The projection lens system 314 is for condensing the laser light 312 onto the sample fluid 313, and consists of a collimating lens 318 as the condenser lens and a pair of cylindrical lenses 321 and 321 in this embodiment.

Note that in this embodiment the collimating lens 318 shares a common design with the lenses (16A or 16B) configuring the light-receiving lens system 316.

The collimating lens 318 collimates the laser light 312 emitted from the light source 311 to parallel beams. The two cylindrical lenses 321 are compressed in the direction perpendicular to the page in FIG. 10(B) to be band-like, by which the elliptic laser light 312 is further changed to a flat, band-like laser beam 312a. By changing the laser light into the band-like laser beam 312a, the energy density of the laser light 312 is increased.

More specifically, the band-like laser beam 312a is wider than the size of the sample fluid 313 circulated by the fluid path means 330, and the sample fluid 313 perpendicularly crosses the traveling direction of the band-like laser beam 312a. Also, in the direction of the wider width of the band-like laser beam 312a, the band-like laser beam 312a travels across the entire width of the sample fluid 313.

In this embodiment, the band-like laser beam 312a has a width of 4 mm (the width in the direction perpendicular to the page of FIG. 10(A)) and a thickness of 50 μm (the thickness in the top-bottom direction in FIG. 10(A)), for example.

A beam pocket 350 is arranged downstream of the projection lens system 314. The beam pocket 350 traps the projected band-like laser beam 312a. With this, stray light caused by the reflection of the band-like laser beam 312a inside the device 301 is reduced to reduce background noise entering the light-receiving device 317 as a photo detector. Thus, the S/N ratio can be raised to amplify the signal.

The fluid path means 330 is for circulating the sample fluid 313 containing particles 313a in a constant direction, and is configured by a airtight section 331 arranged downstream of the projection lens system 314, a supply tube 332 for supplying the sample fluid 313 to the airtight section 331 and a suction pump 340 for creating negative pressure in the airtight section 331. Also, the measuring area 335 corresponds to the intersection between the band-like laser beam 312 and the sample fluid 313.

The light-receiving lens system 316 is opposed to the measuring area 335, and the optical axis thereof is perpendicular to the optical axis of the band-like laser beam 312a. The photo detector 317 is a light-receiving device at which the condensed scattered light 315 undergoes the photoelectric conversion; in this embodiment, the light-receiving device 317 uses an APD (Avalanche Photodiode) capable of detecting a light of very little intensity. With this, the sensitivity and the SN ratio can be increased.

### (Configuration of Light-Receiving Lens System)

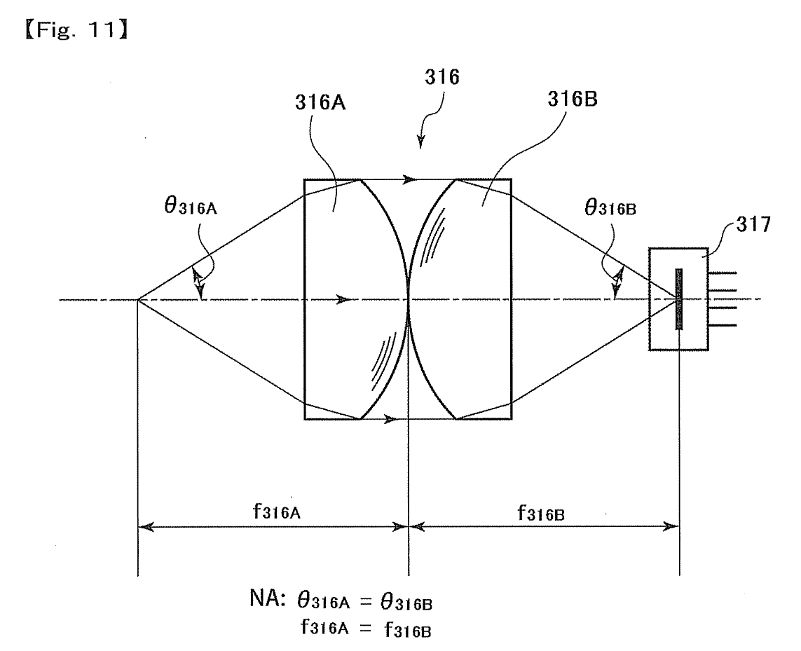

FIG. 11 is a cross-sectional view of a light-receiving lens system applied in a light-scattering particle counter of at least an embodiment of the present invention.

The light-receiving lens system 316 consists of two planoconvex lenses 316A and 316B; as shown in FIG. 11, they are arranged such that the convex surfaces thereof are in contact. Also, each of the planoconvex lenses 316A and 316B are molded of resin and they are identical. Note that the lenses need not be limited to the identical ones, but two lenses having different NA may be combined. Also, the two lenses 316A and 316B need not be in contact.

Further, the lens in this embodiment has an outside dimension of φ4.7 and an NA of 0.47. Because of this, the optical system of the light-scattering particle counter 301 can be downsized.

Also, the light-receiving lens system 316 is applicable as an objective lens for a normal CD pickup. Therefore, it is preferred that the wavelength of the laser diode 311a as a light source be 600 nm to 800 nm; in this embodiment, the wavelength of the laser diode 311a is 785 nm. In order to raise the sensitivity as much as possible, it is preferred that the laser diode 311a be one used for high-output CD recording.

When a laser diode 311a having the wavelength of 785 nm is used, a light-receiving device 317 that responds to this wavelength with high sensitivity is used. Therefore, the scattered light 315 generated by the particle 313a can be detected with high sensitivity. In this embodiment, the light-receiving device 317 can adopt a relatively-low-priced, popular APD (Avalanche Photodiode). Further, for detecting the particles having the particle size of 0.005 μm to 0.3 μm in the light-scattering particle counter 301, the laser diode 311a having a wavelength that can use Rayleigh Scattering Method can be selected for the particles in such sizes.

Although the above-mentioned light-receiving lens system 316 is applicable as an objective lens for a normal CD pickup, it may be other than this. More specifically, it may be applicable as a DVD pickup objective lens.

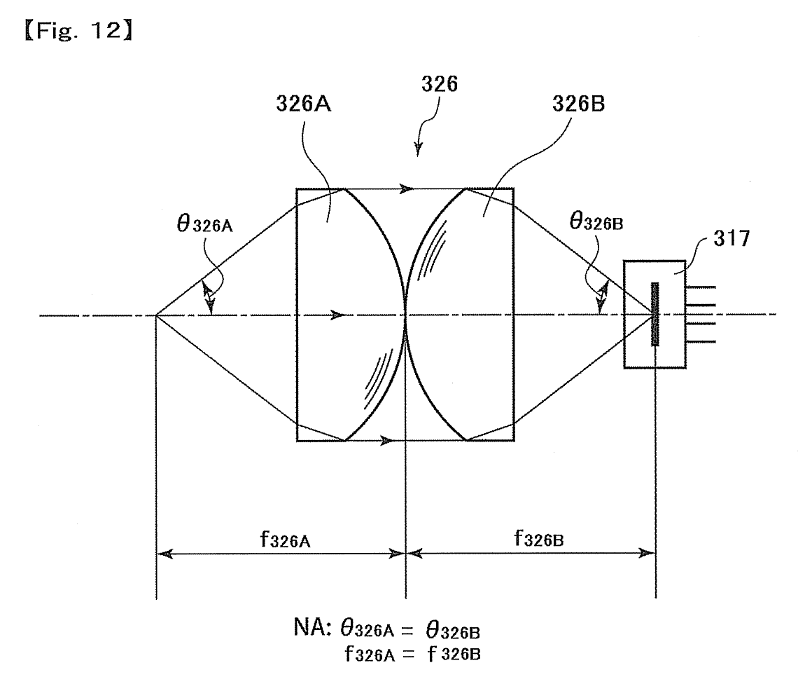

Another light-receiving lens system 326 is described next referring to FIG. 12. FIG. 12 is a cross-sectional view of another light-receiving lens system that is applied to the light-scattering particle counter of at least an embodiment of the present invention.

In this embodiment, as shown in FIG. 12, the light-receiving lens system 326 consists of two planoconvex lenses 326A and 326B; they are arranged such that the convex surfaces thereof are in contact. Also, each of the planoconvex lenses 326A and 326B are molded of resin and they are identical. Note that the lenses need not be identical, but two lenses having different NA may be combined. Also, the two lenses 316A and 316B need not be in contact.

Further, the lens in this embodiment has an outside dimension of φ5.0 and an NA of 0.6. Because of this, the optical system of the light-scattering particle counter 310 can be downsized.

The light-receiving lens system 326 is applicable as an objective lens for a DVD pickup. Therefore, it is preferred that the wavelength of the laser diode 311a as a light source be 600 nm to 800 nm; in this embodiment, the wavelength of the laser diode 311a is 660 nm. In order to raise the sensitivity as much as possible, it is preferred that the laser diode 311a be one used for high-output DVD recording.

When the laser diode 311a having the wavelength of 660 nm is used, the light-receiving device 317 that responds to this wavelength with high sensitivity is used. Therefore, the scattered light 315 generated from the particle 313a can be detected with high sensitivity. In this embodiment, the light-receiving device 317 can adopt a relatively-low-priced, popular APD (Avalanche Photodiode). Further, for detecting the particles 313a having the particle size of 0.005 μm to 0.3 μm in the light-scattering particle counter 301, a laser diode 311a having the wavelength that can use Rayleigh Scattering is selected for the particles in such sizes.

In the embodiment that uses the light-receiving lens system 320, the collimating lens 318, which is a component of the projection lens system 314, is a lens sharing the same design specification of the lens 326A (or 326B) configuring the light-receiving lens system 326.

The operation of the above-mentioned light-scattering particle counter 301, 310 is described hereinafter.

The elliptical shaped laser light 312 emitted from the laser diode 311a as a light source is transmitted through the projection lens system 314 and exits as the band-like laser beam 12a. More specifically, the laser light 312 is collimated to be a parallel beam by the collimating lens (condenser lens) 318, and is transmitted through the cylindrical lens 321 to be formed as a further deflected band-like laser beam 312a.

The band-like laser beam 312a is projected to the airtight section of the fluid path means 330. Meanwhile, the sample fluid is flowed in the airtight section 331 by the operation of the suction pump 340. Then, the band-like laser beam 312a passes through the sample fluid 313. The projected band-like laser beam 312a is wider than the size of the sample fluid 313 circulated by the fluid path means 330, and the sample fluid 313 crosses at a right angle with respect to the traveling direction of the band-like laser beam 312a. Also, in the direction of the wider width of the band-like laser beam 312a, the band-like laser beam 312a passes across the entire width of the sample fluid 313. In other words, the band-like laser beam 312a is formed such that the width thereof in the direction perpendicular to the page of FIG. 10(A) is wider than the flow of the sample fluid 313 in the outmost layer, and passes across the flow of the sample fluid in the outmost layer in the direction perpendicular to the page.

When the sample fluid 313 contains particles 313a, the scattered light 315 is generated from the measuring area 335. The scattered light is transmitted through the light-receiving lens system 316 and enters the light-receiving device 317 which is a photo detector. Based on the fact that there is a relative relationship between the size of the pulse of the electric output obtained from the light-receiving device 317 and the particle size of the particles 313a, the particle size can be obtained by using the size of the pulse of the electric output. Also, since a pulse is generated when the particle 313a passes, the number of the particles can be obtained from the number of the pulses.

### (Major Effects of This Embodiment)

The light-scattering particle counter 301, 310 is equipped with the projection lens system 314 for condensing the laser light 312 emitted from the laser diode 311a onto the sample fluid 313, the light-receiving lens system 316 for condensing the scattered light 315 generated by irradiating the particles 313a in the sample fluid 313 with the band-like laser beam 312a, and the light-receiving device 317 for detecting the condensed scattered light 315; the light-receiving lens system 316 is configured by two lenses 316A and 316B having an NA of 0.47. Note that it is preferred that the wavelength of the laser diode 311a be 785 nm.

According to this embodiment, the light intensity of the laser light 312 emitted from the laser diode 311a can be effectively used, increasing the S/N ratio. The light-receiving lens system 316 is configured by two planoconvex lenses 316A and 316B; as shown in FIG. 11, they are arranged such that the convex surfaces thereof are in contact. Also, each of the planoconvex lenses 316A and 316B is molded of resin and they are identical.

In this embodiment, the light-receiving lens system 316 may be configured by two lenses 326A and 326B having an NA of 0.6. Note that it is preferred that the wavelength of the laser diode 311a be 660 nm.

Thus, in this embodiment, the light-receiving lens system 316 is applicable as a normal CD pickup objective lens. Also, the light-receiving lens system 326 is applicable as a DVD pickup objective lens. Thus, the light-receiving lens systems 316 and 326 are designed for laser optical systems; therefore, aberration of the laser light 312 can be minimized, and the light intensity of the laser light 312 emitted from the laser diode 311 can be effectively used. For this reason, the light-scattering particle counters 301 and 310 can detect with high sensitivity.

Furthermore, since the light-receiving lens systems 316 and 326 are designed with a specification of the wavelength of the laser diode 311a of 800 nm or less, a popular light-receiving device 317 (APD) of relatively low cost can be used. For detecting the particles 313a having the diameter of 0.05 μm to 0.3 μm, the wavelength of the laser diode 311a that can use Rayleigh Scattering can be selected.

Note that the above embodiment is an example of at least a suitable embodiment of the present invention; however, it is not limited to this, but can be varyingly modified within the scope of the present invention. For example, the light-receiving lenses 316A and 316B and the collimating lens (condenser lens) 318 are molded of resin; however, it's not limited to this, but a glass lens may be used as long as the lens has an NA of 0.45 or more and can be downsized.

The collimating lens (condenser lens) 318 need not share the same design specification as that of the lens 316A (316B, 326A, 326B) that configure the light-receiving lens system 316, 326. Also, the light-receiving lens 316A (326A) arranged closer to the scattered light 315 need not be the same as the light-receiving lens 316B (326B) arranged on the side close to the light-receiving device 317. Note that it is better that the NA of the light-receiving lens 316A (326A) arranged on the side close to the scattered light 315 is larger than that of the light-receiving lens 316B (326B) arranged on the side close to the light-receiving device 317 so that more of light amount can be condensed to increase the sensitivity of the particle counter.

The above-described light-receiving lens system is suitable for a half height type pickup having a relatively large outside dimension; however, it is possible to use a small-size lens for a slim or ultra-slim pickup. In this way, while maintaining the detection sensitivity, the device can be made further smaller and lighter in weight.

Further, the flow of the sample fluid 313 is at 90 degree with respect to the wider plane of the band-like laser beam 312a in this embodiment; however, it may be at 45 degrees or any other angle.

Also, the elliptic shaped laser light 312 is further changed to a flat shape by using the cylindrical lens 321 in each of the above-described embodiments; however, the elliptic shape laser light 312 may be irradiated onto the sample fluid 313 as is. Even at that time, the laser light 312 is like a wide band; therefore, the sample fluid 313 in a wider area can be irradiated.

In each of the above-described embodiments, the band-like laser beam 312a directly irradiates the sample fluid flowing between the supply tube 332 and the suction pump 340; however, the sample fluid 313 may be flowed in a pipe composed of a transparent body that transmits the band-like laser beam 312a, and then the band-like laser beam 312a irradiates the sample fluid 313 from the outside the pipe.

Furthermore, in each of the above-described embodiments, the laser light 312 emitted from the light source 311 is transmitted through the two cylindrical lenses 321 through which the laser light is compressed in the direction perpendicular to the page (FIG. 10(B)) to be the band-like laser beam 312a; however, the projection lens system 314 may be configured by the collimating lens 318 and a single cylindrical lens 321, and the band-like laser beam 312a may pass through the sample fluid 313. According to this configuration, the band-like laser beam 312a that has been transmitted through the cylindrical lens 321 is not a complete parallel beam; however, since the measuring area 335 is narrow, the beam can be regarded as a parallel beam, which enables it to obtain the quantity of particles in the same manner as the above-described embodiments.

Also, in the light-scattering particle counter, a reflective mirror may be arranged opposite to the light-receiving device and the light-receiving lens system. In this way, the scattered light that has scattered in the opposite direction from the light-receiving device is reflected at the reflective mirror to be condensed on the light-receiving device, thus obtaining the number of the particles more efficiently.

In this embodiment, the light-receiving device 317 is an APD (Avalanche Photodiode); however, it is not limited to this.

### Fourth and Fifth Embodiments

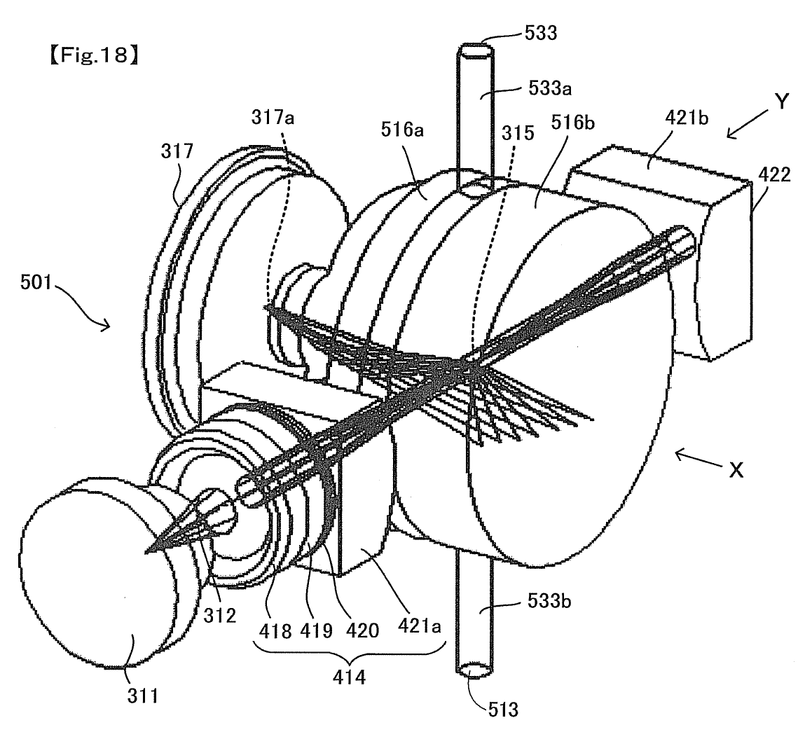

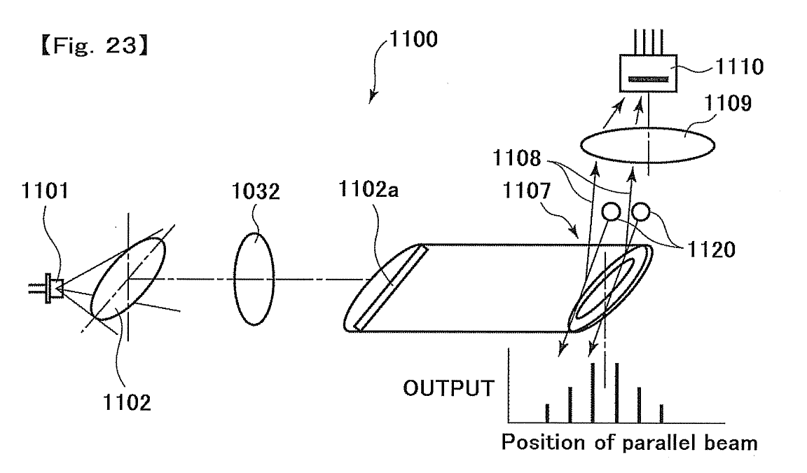

At least some embodiments of the present invention are described hereinafter referring to the drawings. More specifically, the fourth embodiment refers to FIG. 13 through FIG. 17 and the fifth embodiment refers to FIG. 18 through FIG. 23.

FIG. 13 is a perspective view of a mechanical structure of a particle counter 401 of at least this embodiment of the present invention. FIG. 18 is a perspective view of a mechanical structure of a particle counter 501 of this embodiment of at least an embodiment of the present invention. Note that in these embodiments, a particle counter is a light-scattering particle counter for measuring the number of airborne particles by using a light scattering property, and will be described as “a light-scattering particle counter 401” or “a light-scattering particle counter 501” hereinafter. Also, the same codes used in the figures are common to the ones used in the above descriptions.

In FIG. 13, a light-scattering particle counter 401 comprises a light source 311 for emitting laser light 312, a projection lens system 314 for condensing the laser light 312 onto a sample fluid (air, for example) 313, a second mirror surface (spherical mirror) 416a′ and a first mirror surface (elliptic mirror) 416b′ for condensing the scattered light 315 generated as the laser light 312 strikes the particles in the sample fluid 313, and a photo detector 317 for detecting the condensed scattered light 315. By analyzing the number of the voltage pulses obtained from the photo detector 317, the number of the particles can be obtained or measured.

In FIG. 18, a light-scattering particle counter 501 comprises a light source 311 for emitting laser light 312, a projection lens system 414 for condensing the laser light 312 onto a sample fluid 513 flowing inside a light-transmitting fluid path 533 (water, for example), a first lens 516b and a second lens 516a for condensing the scattered light 315 generated as the laser light 312 strikes the particles in the sample fluid 513, and a photo detector 317 for detecting the condensed scattered light 315. By analyzing the number of the voltage pulses obtained from the photo detector 317, the number of the particles is obtained or measured. Note that a tube 533a and a tube 533b are respectively provided to the inlet and outlet of the sample fluid 513; they constitute part of the transmitting fluid path 533. Also, the base ends of the tubes 533a and 533b are sealed by O-rings, etc.

An irradiation optical system of the light-scattering particle counter 401 (the light-scattering particle counter 501 shown in FIG. 18) is first described in detail. The light source 311 is a laser diode, and laser light 312 emitted from the laser diode is transmitted through the projection lens system 414 and irradiated to a sample fluid 313. The projection lens system 414 is configured by a collimating lens 418, a polarizing plate 419, a λ/4 plate (quarter wave plate) 420, and a cylinder lens 421 (a pair of identical cylinder lenses 421a and 421b).

The collimating lens 418 collimates the laser light 312 emitted from the light source 311 to a parallel light (parallel beam); the polarizing plate 419 transmits only the light having a plane of vibration in a specific direction among the laser light 312 (polarizes the laser light 312).

The λ/4 plate functions to cause a λ/4 phase difference to the linearly-polarized light that has passed through the polarizing plate 419, thus converting the linearly-polarized light into a circularly-polarized light. More specifically, when the linearly-polarized light enters the λ/4 plate 420 under the condition where the vibration direction of the linearly-polarized light is at +45 degrees with respect to the optical axial direction of the λ/4 plate 420, the outgoing beam is a circularly-polarized light with right rotation. On the other hand, the linearly-polarized light enters the λ/4 plate 420 under the condition where the vibration direction of the linearly-polarized light is at −45 degrees with respect to the optical axial direction of the λ/4 plate 420, the outgoing beam is a circularly-polarized light with left rotation.

The cylinder lens 421a has a flat surface on the side on which the laser light 312 enters and a convex-curved surface (a cylinder surface) on the side from which the laser light 312 exits. In other words, the flat surface is formed on the side far from the laser-irradiated area (the measuring area) in the fluid path 433 (the light-transmitting fluid path 533 illustrated in FIG. 18) in which the sample fluid 313 flows, and the convex-curved surface is formed on the side close to the measuring area. Therefore, the laser light 312 that has passed through the cylinder lens 421a is gradually compressed in the direction the sample fluid flows; by the time the laser light 312 crosses the fluid path 433 (the transmitting fluid path 533 illustrated in FIG. 18) in which the sample fluid 313 flows, it is converted into a band-like (flat) bundle of beams (near a focal point). In this way, the energy density (irradiation light intensity) of the laser light 312 is increased to raise the sensitivity of the light-scattering particle counter 401 (or the light-scattering particle counter 501 illustrated in FIG. 18).

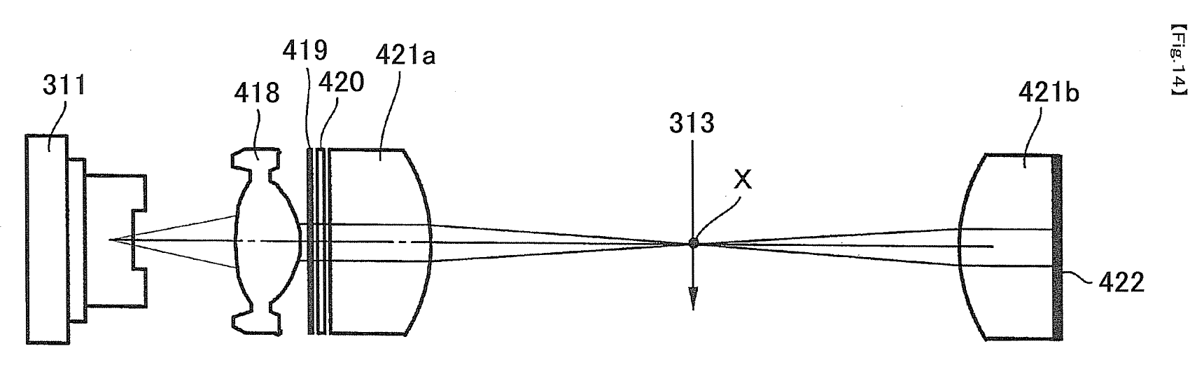

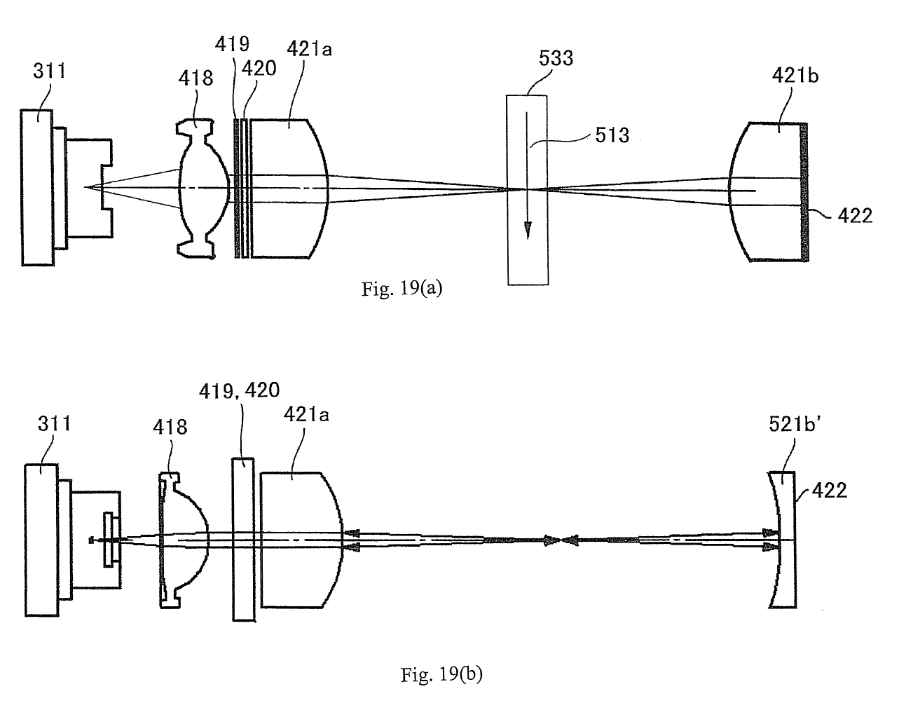

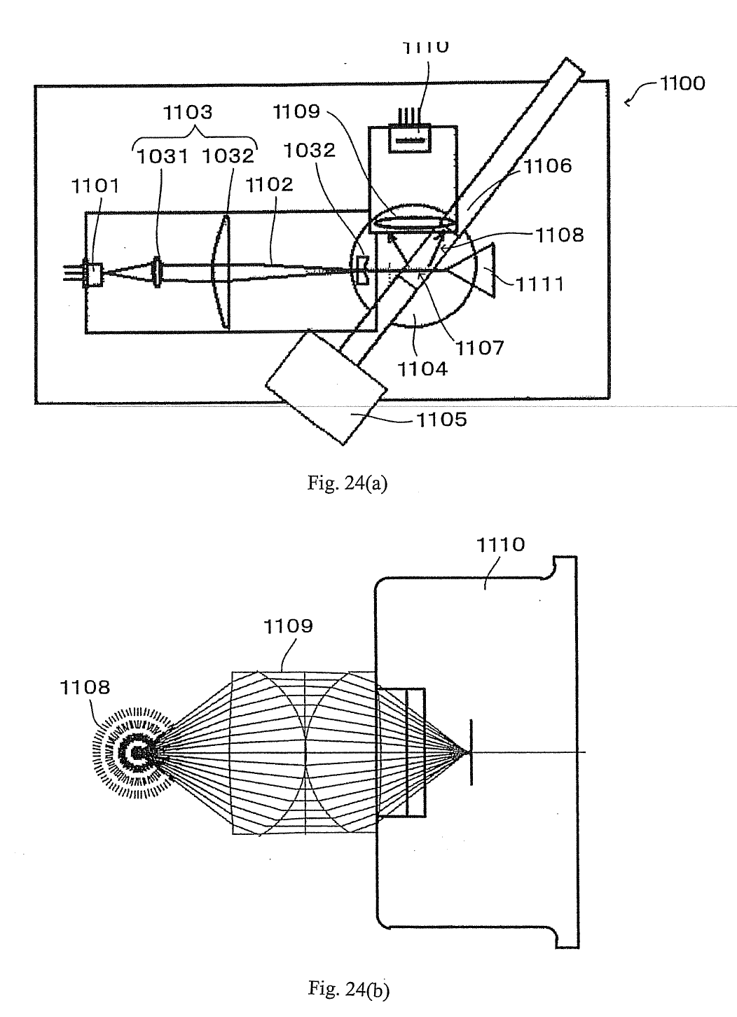

In the conventional light-scattering particle counter 1100 (see FIG. 24(a)), the beam pocket 1111 is arranged downstream of the projection lens 1103 to trap the laser light 1102 that did not strike particles, as described above. However, in the light-scattering particle counter 301 of this embodiment, the pair of identical cylinder lenses 421a and 421b are used to effectively use the laser light 1102 that did not strike particles. It will be described in detail referring to FIG. 14 and FIG. 19(a).

FIG. 14 is a side view of the light-scattering particle counter 401 shown in FIG. 13. Note that the illustration of the second mirror surface (spherical mirror) 416a′ and the first mirror surface (elliptical mirror) 416b′ and the photo detector 317 is omitted in FIG. 14 for convenience of explanation.

In the same manner, in the fifth embodiment, FIG. 19(a) is a side view of the light-scattering particle counter 501 shown in FIG. 18. Note that the illustration of the first lens 516b and the second lens 516a and the photo detector 317 is omitted in FIG. 19(a) for convenience of explanation. FIG. 19(a) is also a side view of FIG. 18 observed from the X direction.

In FIG. 14 and FIG. 19(a), the light source 311, the collimating lens 418, the polarizing plate 419, the λ/4 plate 420 and the cylinder lens 421a function as described above. The cylinder lens 421b has a convex-curved surface (cylinder surface) on the side from which the laser light 312 enters and a flat surface on the opposite side of the lens. In other words, the flat surface is formed on the side far from the laser-irradiated area (the measuring area) in the fluid path 433 (the transmitting fluid path 533 illustrated in FIG. 18) in which the sample fluid 313 flows, and the convex-curved surface (cylinder surface) is formed on the side close to the measuring area. In this manner, a pair of identical cylinder lenses 421a and 421b are arranged interposing the measuring area between them.

Over the flat surface of the cylinder lens 421b, a mirror coating 422 (shown by thick lines in FIG. 14 or FIG. 19(a)) is applied to reflect the laser light 312. Note that, although the mirror coating 422 is adopted as a reflective member for reflecting the laser light 312 in this embodiment, a glass bead or prism may be provided on the flat surface or a reflective sheet may be adhered to the flat surface. For the mirror coating 422, any kind of mirror coating such as a silver mirror coating, a gold mirror coating, a blue mirror coating, or a pink mirror coating may be used.

The laser light 312 that has exited from the cylinder lens 421a becomes a flat beam at the focal point, X (see FIG. 14 or FIGS. 19(a) and (b)), and then is expanded again and enters the cylinder lens 421b in the same shape as the beam spot formed immediately after the light exits the cylinder lens 421a. The laser light 312 that has passed through the cylinder surface of the cylinder lens 421b returns to the shape of the laser light 312 formed immediately before the light exits the cylinder lens 421a (to a parallel beam). Then, the laser light 312 in the form of the parallel light (parallel beam) is reflected at the mirror coating 422, and exits from the cylinder surface of the cylinder lens 421b again. At that time, almost no scattered light is generated at the interface (most of the laser light that has hit the reflective member properly returns).

By shaping the beam with the cylinder surface of the cylinder lens 421b and reflecting the laser light 312 by the mirror coating 422 applied over the flat surface, most of the laser light 312 that has hit the mirror coating 422 can be directed again to the focal point, X, so that the scattered light generated by the interface is reduced, thus reducing loss of light.

The laser light 312 that has exited from the cylinder surface of the cylinder lens 421b and has been converted to a circularly-polarized light becomes a flat beam at the focal point, X, and is expanded again and then enters the cylinder surface of the cylinder lens 421a. When the laser light 312 converted to a parallel light (parallel beam) by the cylinder surface of the cylinder lens 421a passes through the λ/4 plate 420, a λ/4 phase difference occurs.

Since this laser light 312 has passed the λ/4 plate 420 once when first emitted from the light source 311 toward the focal point, X, it returns to be the light having a plane of vibration in the direction perpendicular to the linearly-polarized light at the time of going toward the focal point, X, from the light source 311 as a result. Therefore, after being transmitted through the λ/4 plate 420, the laser light 312 is light-shielded at the polarizing plate 419. In this way, the laser light 312 reflected from the mirror coating 422 is prevented from returning to the light source 311.

Note that, although the irradiation optical system adopts the configuration shown in FIG. 19(a) in the fifth embodiment, it may adopt the configuration shown in FIG. 19(b). In other words, in place of the cylinder lens 421b, a reflective member 521b′ may be used. The reflective member 521b′ reflects the laser light which temporarily becomes a flat, band-like beam at a focal point and then expands as it travels away from the focal point, and converts the light back to the flat, band-like beam at the same focal point of the lens near the light source.

The condenser system of the light-scattering particle counter 401 is described next in detail. As shown in FIG. 13, the condenser system is configured by the second mirror surface (spherical mirror) 416a′ and first mirror surface (elliptic mirror) 416b′ for condensing the scattered light 315 and the photo detector 317 for detecting the condensed scattered light 315.

The condensing system of the light-scattering particle counter 501 is described in detail next. As shown in FIG. 18, the condenser system is provided between the first lens 516b and second lens 516a for condensing the scattered light 315, and configured by the light-transmitting fluid path 533 in which a sample fluid flows and the photo detector 317 for detecting the condensed scattered light 315.

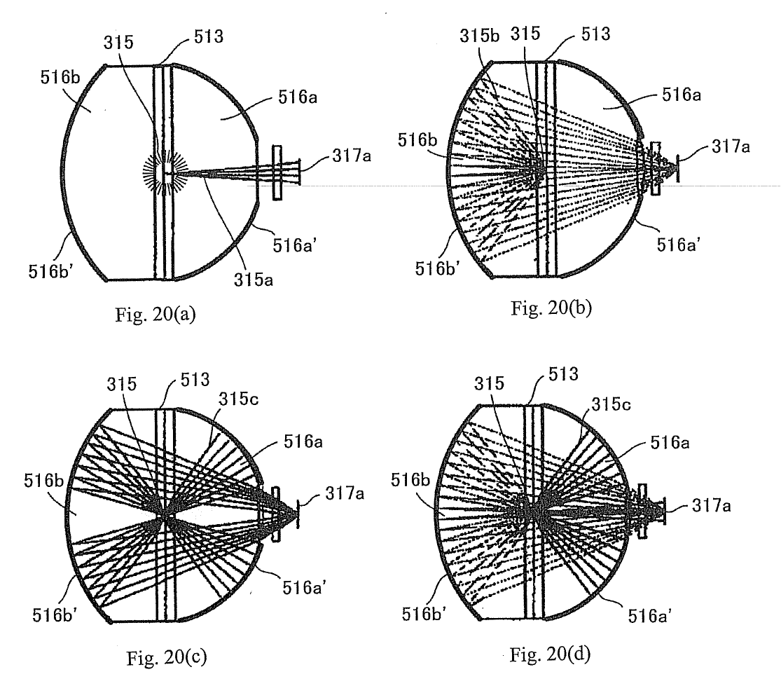

In FIG. 18, the first lens 516b has the first mirror surface 516b′ for condensing the reflection light onto the light-receiving surface 317a of the photo detector 317 (see FIGS. 20(a)-20(d)) and is opposed to the photo detector 317 via the measuring area. The second lens 516a is used for collecting the reflection light onto the measuring area and arranged in the vicinity of the light-receiving surface 317a of the photo detector 317. More specifically, the second mirror surface 516a′ having a hole in the same shape as that of the light-receiving surface 317a of the photo detector 317, is adhered such that the hole is in contact with the periphery of the light-receiving surface 317a. Later is described how the scattered light 315 is condensed onto the light-receiving surface 317a of the photo detector 317 by the first lens 516b and the second lens 516a (see FIGS. 20(a)-20(d)).

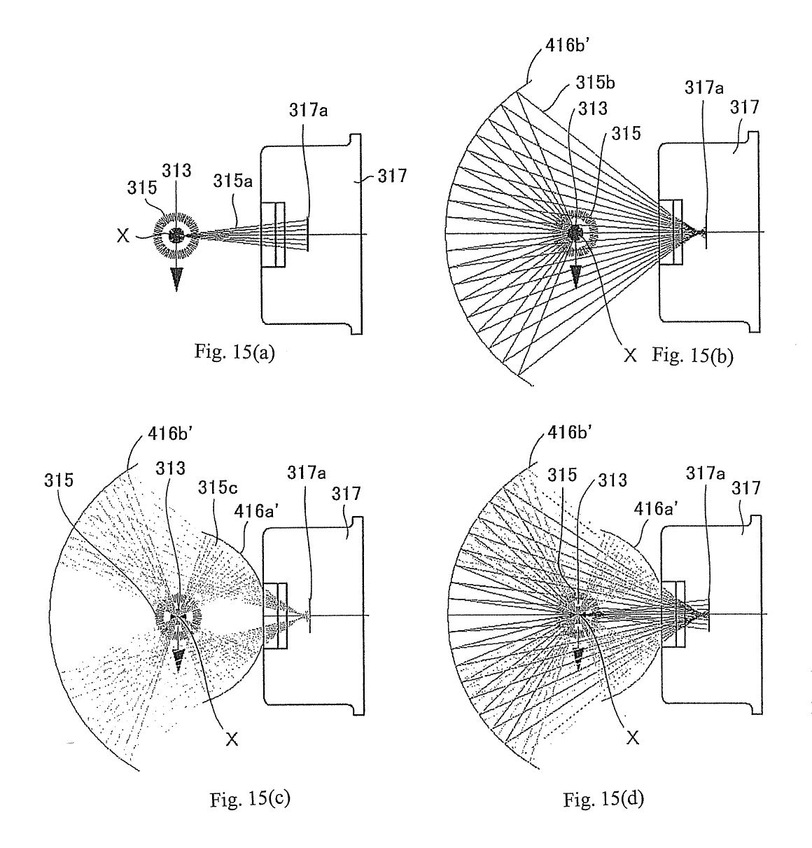

In FIG. 13, the second mirror surface (spherical mirror) 416a′ is used for condensing the reflection light onto the measuring area and arranged in the vicinity of the light-receiving surface 317a of the photo detector 317. More specifically, the second mirror surface (spherical mirror) 416a′ having a hole of the same shape as that of the light-receiving surface 317a of the photo detector 317, is adhered such that the hole is in contact with the periphery of the light-receiving surface 317a. Also, the first mirror surface (elliptic mirror) 416b′ is for condensing the reflection light onto the light-receiving surface 317a of the photo detector 317 and opposed to the photo detector 317 via the measuring area. Later is described how the scattered light 315 is condensed onto the light-receiving surface 317a of the photo detector 317 by the second mirror surface (spherical mirror) 416a′ and the first mirror surface (elliptic mirror) 416b′ (see FIGS. 15(a)-15(d)).

The photo detector 317 faces the measuring area and is arranged such that the optical axis thereof is perpendicular to the optical axis of the laser light 312. The photo detector 317 is an example of the light-receiving device, and can adopt SiPIN photo diode with pre-amp. With this, the sensitivity and SN ratio can be improved.

FIGS. 15(a) through 15(d) are explanatory diagrams to explain how the scattered light 315 is condensed onto the light-receiving surface 317a of the photo detector 317 in the light-scattering particle counter 401 illustrated in FIG. 13. Note that the illustration of the light source 311, projection lens system 414, etc. is omitted in FIGS. 15(a) through 15(d) for convenience of explanation.

FIGS. 20(a)-20(d) are explanatory diagrams to show how the scattered light 315 is condensed on the light-receiving surface 317a of the photo detector 317 in the light-scattering particle counter 501 illustrated in FIG. 18. Note that the illustration of the light source 311, the projection lens system 414, etc. is omitted in FIGS. 20(a)-20(d)for convenience of explanation. Also, FIGS. 20(a)-20(d) are side views of FIG. 18 observed in the Y direction.

As shown in FIG. 15(a), a portion 315a of the scattered light 315 generated as the laser light 312 strikes the sample fluid 313 at the focal point, X, directly enters the light-receiving surface 317a of the photo detector 317.

As shown in FIG. 15(b), a portion 315b of the scattered light 315 generated as the laser light 312 strikes the sample fluid 313 at the focal point, X, is directed opposite from the photo detector 317; the scattered light 315b is reflected from the first mirror surface (elliptic mirror) 416b′ and condensed/incident on the light-receiving surface 317a of the photo detector 317. In this way, the scattered light 315b undergoes a reflection once at the first mirror surface (elliptic mirror) by the time of incidence on the light-receiving surface 317a of the photo detector 317.

As shown in FIG. 20(b), the scattered light 315b generated as the laser light 312 strikes the sample fluid 513 at the focal point, X, is directed opposite from the photo detector 317; the scattered light 315b is reflected from the first mirror surface 516b′ of the first lens 516b (the elliptic mirror surface formed with a mirror coating applied), and condensed/incident on the light-receiving surface 317a of the photo detector 317. In this way, the scattered light 315b experiences reflection at the first mirror surface 516b′ once by the time of incidence on the light-receiving surface 317a of the photo detector 317.

As shown in FIG. 15(c), a portion 315c of the scattered light 315 generated as the laser light 312 strikes the sample fluid 313 at the focal point, X, is directed toward the photo detector 317 but misses the light-receiving surface 317a of the photo detector 317; however, such scattered light 315c is reflected from the second mirror surface (spherical mirror) 416a′ and returned to the focal point, X (the measuring area) again. Then, the scattered light 315c passes through the focal point, X, is reflected from the first mirror surface (elliptic mirror) 416b′ and condensed/incident on the light-receiving surface 317a of the photo detector 317, as described referring to FIG. 15(b). Thus, the scattered light 315c undergoes a reflection at the second mirror surface (spherical mirror) 416a′ once and another reflection at the first mirror surface (elliptic mirror) 416b′ once (two reflections in total) by the time of incidence on the light-receiving surface 317a of the photo detector 317.

As shown in FIG. 20(c), a portion 315c of the scattered light 315 generated as the laser light 312 strikes the sample fluid 513 at the focal point, X, is directed toward the photo detector 317 but misses the light-receiving surface 317a of the photo detector 317; however, the scattered light 315c is reflected from the second mirror surface 516b′ of the second lens 516b (spherical mirror with a mirror coating applied) and returned to the focal point, X (the measuring area) again. Then, the scattered light 315c passes through the focal point, X, is reflected from the first mirror surface 516b′ and condensed/incident on the light-receiving surface 317a of the photo detector 317, as described referring to FIG. 20(b). Thus, the scattered light 315c undergoes a reflection at the second mirror surface 516a′ once and another reflection at the first mirror surface 516b′ once (two reflections in total) by the time of incidence on the light-receiving surface 317a of the photo detector 317.

FIG. 15(d) shows a combination of the optical paths of the scattered light 315 shown in FIG. 15(a) through FIG. 15(c). In FIG. 15(d), light other than the scattered light 315a (see FIG. 15(a)) that directly enters the light-receiving surface 317a of the photo detector 317 can be effectively detected.

As described above, according to the irradiation optical system of the light-scattering particle counter 401 of this embodiment, the particles in the sample fluid 313 can be irradiated by the laser light 312 that travels back and forth (see FIG. 14), the irradiation light intensity at the measuring area can be doubled, increasing the sensitivity of the light-scattering particle counter 301.

Also, a pair of lenses comprised of the cylinder lens 421a and the cylinder lens 421b are arranged such that the cylinder surfaces thereof are opposed to each other via the measuring area (or the focal point, X) on which the laser light 312 is irradiated; since the mirror coating 422 is applied over the flat surface of the cylinder lens 421b, the reshaping of the beam and the returning of the laser light 312 can be simultaneously performed, reducing the scattered light generated at the interface to reduce loss of light and increasing the sensitivity of the light-scattering particle counter 301.

Particularly, in the light-scattering particle counter 401 of this embodiment, the cylinder lens 421a and the cylinder lens 421b are identical. Because of this, the number of different components is reduced, contributing to reduction of manufacturing cost.

Between the cylinder lens 421a and the light source 311, the polarizing plate 419 and the λ/4 plate 420 are interposed; therefore, the laser light 312 reflected at the mirror coating 422 is prevented from returning to the light source 311, thus preventing damage to the light source 311.

According to the condensing system of the light-scattering particle counter 401 of this embodiment, light other than the scattered light 315 directly incident on the light-receiving surface 317a of the photo detector 317 can be detected by the second mirror surface (spherical mirror) 416a′ and the first mirror surface (elliptic mirror) 416b′ (see FIGS. 15(a)-15(d)); therefore, even when a normal, inexpensive photo detector 317 is used, a high NA can be realized, resulting in reduced manufacturing cost and increased sensitivity of the light-scattering particle counter 401.

Also, according to the condensing system of the light-scattering particle counter 501 of this embodiment, light other than the scattered light 315 directly incident on the light-receiving surface 317a of the photo detector 317 can be detected by the second mirror surface 516a′ in the second lens 516a and the first mirror surface 516b′ in the first lens 516b (see FIG. 20); therefore, even when a normal, inexpensive photo detector 317 is used, a high NA can be realized, resulting in reduced manufacturing cost and increased sensitivity of the light-scattering particle counter 501.

More specifically described, the scattered light 315b traveling away from the photo detector 317 is reflected at the first mirror (elliptic mirror) 416b′ and condensed onto the light-receiving surface 317a of the photo detector 317 so that an NA of 0.95 can be achieved (see FIG. 15(b)). This is a high NA which is 1.6 times more than a conventional one. Also, the scattered light 315c that is directed toward the photo detector 317 but does not directly enter the light-receiving surface 317a of the photo detector 317 is reflected at the second mirror surface (spherical mirror) 416a′, further reflected at the first mirror surface (elliptic mirror) 416b′ and then condensed onto the light-receiving surface 317a of the photo detector 317 to achieve an NA of 0.95 (see FIG. 15(c)). This is a high NA that is about 1.6 times more than a conventional one. Considering that the synthesized light of the scattered lights 315 shown in FIG. 15(b) and FIG. 15(c) enters the light-receiving surface 317a of the photo detector 317 (see FIG. 15(d)), this is a high NA that is about 3.2 times more than a conventional one and the light intensity is about 10 times stronger per unit area. In this way, particles having a minimum measurable particle size of 0.3 μm or less can be detected.

More specifically described, the scattered light 315b traveling away from the photo detector 317 is reflected at the first mirror surface 516b′ and focused on the light-receiving surface 317a of the photo detector 317 to achieve an NA of 0.95 (see FIG. 20(b)). This is a high NA which is 1.6 times higher than a conventional one. Also, the scattered light 315c that is directed toward the photo detector 317 but does not directly enter the light-receiving surface 317a of the photo detector 317 is reflected at the second mirror surface 516a′, further reflected at the first mirror surface 516b′ and then condensed onto the light-receiving surface 317a of the photo detector 317 to achieve an NA of 0.95 (see FIG. 20(c)). This is a high NA that is about 1.6 times higher than a conventional one. Considering that the synthesized light of the scattered lights 315 shown in FIG. 20(b) and FIG. 20(c) enters the light-receiving surface 317a of the photo detector 317 (see FIG. 20(d)), this is a high NA that is about 3.2 times higher compared to a conventional one and the light intensity is about 10 times stronger per unit area. In this way, even the particles having a minimum measurable particle size of 0.3 μm or less can be detected.

The scattered light 315 incident on the light-receiving surface 317a of the photo detector 317 is reflected at most two times; thus while the decrease of light intensity caused by the conversion of light energy to thermal energy is kept as minimal as possible, the sensitivity of the light-scattering particle counter 401 can be increased.

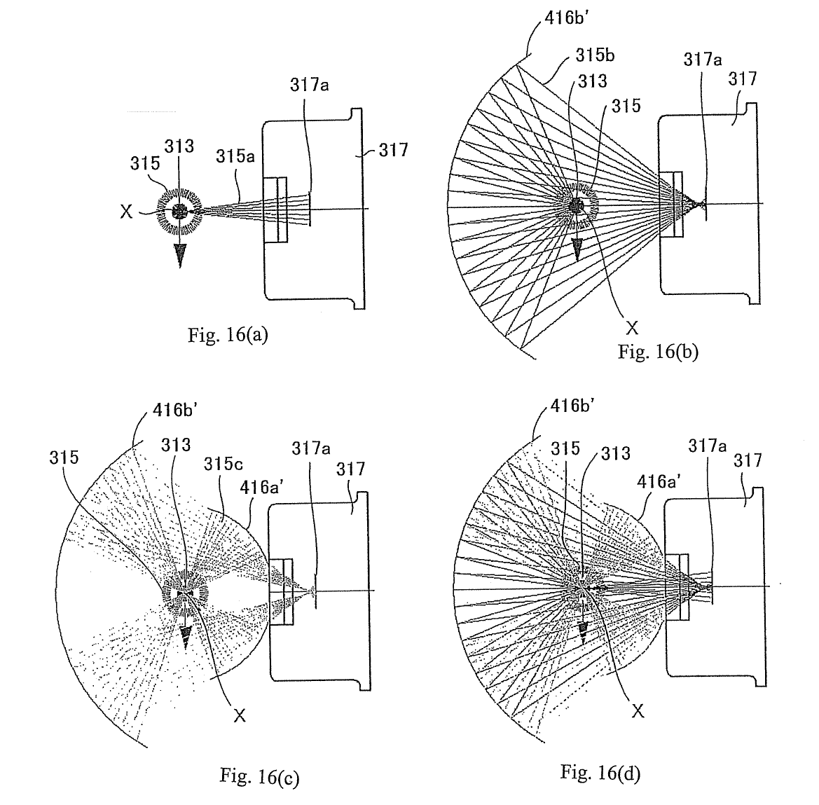

FIGS. 16(a)-16(b) are diagrams of a mechanical configuration of a light-scattering particle counter 401A equipped with a plurality of pairs of cylinder lenses 421a and 421b. Particularly, FIG. 16(a) is a side view of the light-scattering particle counter 401A; FIG. 16(b) is a plan view of the light-scattering particle counter 401A. Note that in FIG. 16(a), the right half shows the external configuration of the light-scattering particle counter 401A and the left half shows the internal configuration of the light-scattering particle counter 401A.

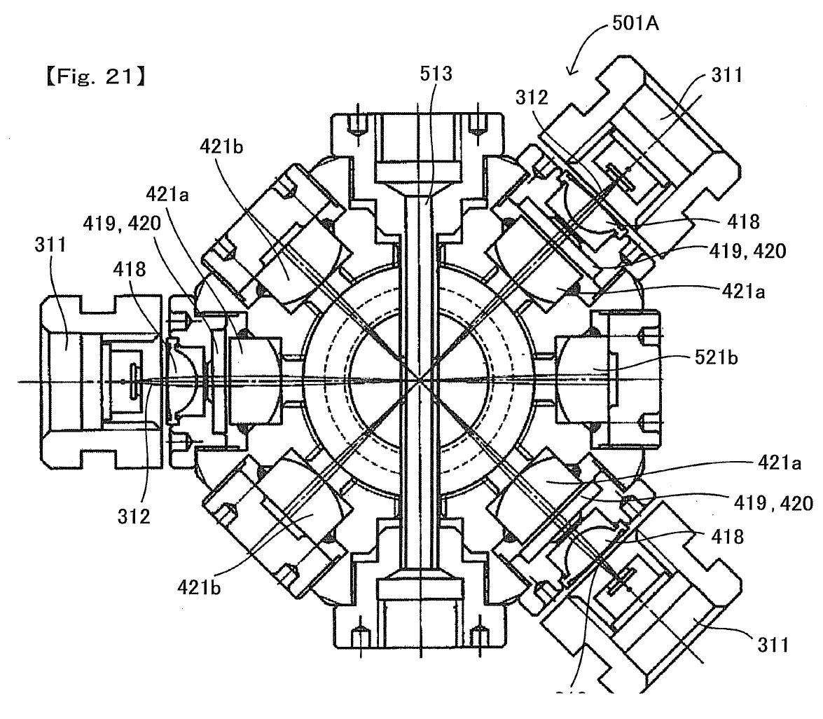

FIG. 21 is a diagram of a mechanical configuration of a light-scattering particle counter 501A equipped with a plurality of pairs of cylinder lenses 421a and 421b. Particularly, it is a plan view of the light-scattering particle counter 501A. Note that in FIG. 21, the photo detector 317 and the second lens 516a are positioned nearer than the measuring area (focal point) on the page and the first lens 516b is positioned farther than the measuring area on the page.

As shown in FIG. 16(a) and FIG. 16(b), the light-scattering particle counter 401A is provided with the photo detector 317 for detecting the scattered light 315 and three pairs of cylinder lenses 421a and 421b arranged on the plane that includes the measuring area (or the focal point, X) and is parallel to the light-receiving surface 317a of the photo detector 317, having the measuring area between them.

The three pairs of lenses and the fluid path 433 in which the sample fluid 313 flows are arranged such that they are mutually shifted by about 45 degrees (see FIG. 16(b)). Therefore, the laser light 312 is irradiated to particles in the sample fluid 313 from various angles so that the period of time during which the scattered light 315 is being generated can be longer. As a result, the scattered light 315 is electrically detected by the photo detector 317 more efficiently, resulting in increased sensitivity of the light-scattered particle counter 401A. Also, compared to a light-scattering particle counter having one pair of lenses, the light intensity can be made three times stronger, resulting in increased sensitivity of the light-scattered particle counter 401A.

The three pairs of lenses and the light-transmitting fluid path 533 in which the sample fluid 313 flows are arranged such that they are mutually shifted by about 45 degrees or 90 degrees (see FIG. 21). Therefore, the laser light 312 is irradiated onto particles in the sample fluid 513 from various angles so that the period of time during which the scattered light 315 is being generated can be longer. As a result, the scattered light 315 is electrically detected by the photo detector 317 more efficiently, resulting in increased sensitivity of the light-scattered particle counter 501A. Also, compared to a light-scattering particle counter having one pair of lenses, the light intensity can be made three times stronger, resulting in increased sensitivity of the light-scattered particle counter 501A.

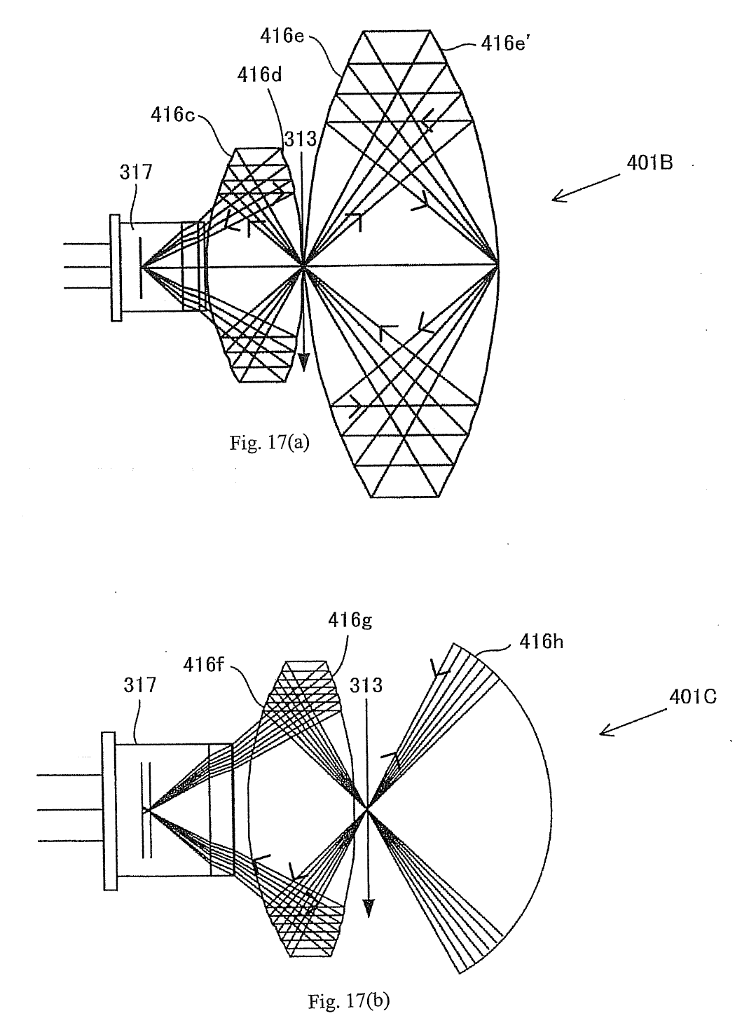

FIGS. 17(a)-17(b) are explanatory diagrams to explain how the scattered light 315 is condensed onto the light-receiving surface 317a of the photo detector 317 in the light-scattering particle counter 401B, 401C of at least another embodiment of the present invention. Note that in FIGS. 17(a)-17(b) only the condensing system is featured while the irradiation optical system is omitted.

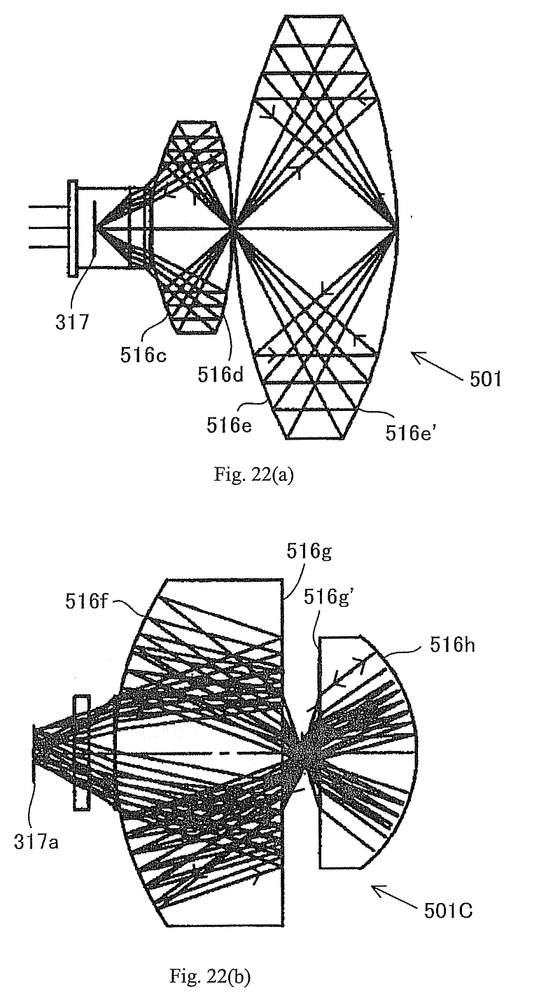

FIGS. 22(a)-22(b) is an explanatory diagram to explain how the scattered light 315 is condensed onto the light-receiving surface 317a of the photo detector 317 in the light-scattering particle counter 501B, 501C of at least another embodiment of the present invention. Note that in FIGS. 22(a)-22(b)only the condensing system is featured while the irradiation optical system is omitted; although the illustration of the transmitting fluid path 533 is also omitted, the sample fluid 513 flows from top to bottom on the page.

The condensing system of the light-scattering particle counter 401B shown in FIG. 17(a) is a combination of the elliptic mirror 416d and parabola mirrors 416c, 416e and 416e′. Some of the scattered light 315 generated from the particles in the sample fluid 313, which travels away from the photo detector 317, enters the light-receiving surface 317a via the optical paths shown by arrows in the figure, for example. In other words, after being reflected at the parabola mirror 416e′, parabola mirror 416e, parabola mirror 416e′, parabola mirror 416e, parabola mirror 416e′, parabola mirror 416c, and elliptic mirror 416d in this order, the light enters the light-receiving surface 317a (see the arrows in the figure).

The condensing system of the light-scattering particle counter 501B shown in FIG. 22(a) is a combination of the elliptic mirror 516d and parabola mirrors 516c, 516e and 516e′. Some of the scattered light 315 generated from the particles in the sample fluid 313, which travels away from the photo detector 317, enters the light-receiving surface via the optical paths shown by arrows in the figure, for example. In other words, after being reflected at the parabola mirror 516e′, parabola mirror 516e, parabola mirror 516e′, parabola mirror 516e, parabola mirror 516e′, parabola mirror 516c, elliptic mirror 516d in this order, the light enters the light-receiving surface 317a (see the arrows in the figure).

Even by combining the elliptic mirror 416d with the parabola mirrors 416c, 416e, and 416e′ in this manner, the scattered light 315 traveling away from the photo detector 317 can be effectively condensed to increase the sensitivity of the light-scattering particle counter 401B.

Even by combining the elliptic mirror 516d with the parabola mirrors 516c, 516e, and 516e′ in this manner, the scattered light 315 traveling away from the photo detector 317 can be effectively condensed to increase the sensitivity of the light-scattering particle counter 501B.

The condensing system of the light-scattering particle counter 401C shown in FIG. 17(b) is a combination of an elliptic mirror 416g, a parabola mirror 416f, and a spherical mirror 416h. Some of the scattered light 315 generated from the particles in the sample fluid 313, which travels away from the photo detector 317, enters the light-receiving surface 317a via the optical paths shown by arrows in the figure, for example. In other words, after being reflected at the spherical mirror 416h, parabola mirror 416f, and elliptic mirror 416g, in this order, the light enters the light-receiving surface 317a (see the arrows in the figure).

The condensing system of the light-scattering particle counter 501C shown in FIG. 22(b) is a combination of flat-surface transmitting portions 516g and 516g′, an elliptic mirror 516f and a spherical mirror 516h. Some of the scattered light 315 generated from the particles in the sample fluid 313, which travels away from the photo detector 317, enters the light-receiving surface 317a via the optical paths shown by arrows in the figure, for example. In other words, after being refracted at the flat-surface transmitting portion 516g′, reflected at the spherical mirror 516h, refracted at the flat-surface transmitting portion 516g′, refracted at the flat-surface transmitting portion 516g, reflected at the elliptic mirror 516f and refracted or reflected at the flat-surface transmitting portion 516g in this order, the light enters the light-receiving surface 317a (see the arrows in the figure).

Even by combining the elliptic mirror 416g with the parabola mirror 416f and the spherical mirror 416h in this manner, the scattered light 315 traveling away from the photo detector 317 can be effectively condensed to increase the sensitivity of the light-scattering particle counter 401C. Further, compared to the light-scattering particle counter 401B, the light is reflected fewer times (seven times in FIG. 17(a) and three times in FIG. 17(b)); therefore, while keeping as minimal as possible the decrease in the light intensity caused when light energy is converted into thermal energy, the sensitivity of the light-scattering particle counter 401C can be increased.

Even by combining the flat-surface transmitting portions 516g and 516g′ with the elliptic mirror 516f and the spherical mirror 516h in this manner, the scattered light 315 traveling away from the photo detector 317 can be effectively condensed to increase the sensitivity of the light-scattering particle counter 501C. Further, compared to the light-scattering particle counter 501B, the light is reflected fewer times (seven times in FIG. 22(a) and three times in FIG. 22(b)); therefore, while keeping as minimal as possible the decrease in the light intensity caused when light energy is converted into thermal energy, the sensitivity of the light-scattering particle counter 501C can be increased.

The light-scattering particle counter of at least an embodiment of the present invention is useful because of its capability of increasing the sensitivity of the particle counter by doubling up the irradiation light intensity in the measuring area and providing a higher NA even when a normal light-receiving device is used.

### (Major Effects of Fourth and Fifth Embodiments)

(1) A particle counter which irradiates the measuring area with laser light emitted from a light source and counts particles present in the measuring area based on the scattered light generated by the particles, wherein a pair of lenses are arranged interposing the measuring area between them, and the pair of lenses respectively have a convex-curved surface on the side near the measuring area and a flat surface on the side far from the measuring area, and a reflective member for reflecting laser light is provided on the flat surface of the lens on the side far or opposite from the light source.

According to at least an embodiment of the present invention (1), in a particle counter equipped with the measuring area which is irradiated by laser light and counting the particles in the measuring area, a pair of lenses, each of which has a convex-curved surface on the side near the measuring area and a flat surface on the side far from the measuring area, are arranged interposing the measuring area between them, and a reflective member for reflecting laser light is provided on the flat surface on one of the pair of lenses on the side far or opposite from the light source; therefore, the laser light that was irradiated onto the measuring area but did not strike particles is transmitted through the one lens of the pair on the side far or opposite from the light source, reflected at the above mentioned reflective member, and then returned to the measuring area again.

In this way, the particles can be irradiated first by the laser light emitted from the light source toward the measuring area and then by the laser light which once has passed through the measuring area and then is returned to the measuring area; thus, the irradiation light intensity in the measuring area can be about two times stronger (less than two times if the reflective ratio is considered), thus increasing the sensitivity of the particle counter.

(1A) A particle counter which irradiates the measuring area with laser light emitted from a light source and counts particles present in the measuring area based on the scattered light generated by the particles, wherein a pair of lenses are arranged interposing the measuring area between them, and the pair of lenses respectively have a convex-curved surface or a concave-curved surface on the side near the measuring area and a flat surface on the side far from the measuring area, and a light-transmitting fluid path in which the particles flow is provided between the pair of lenses and a reflective member for reflecting the laser light is provided on the flat surface of one of the lenses of the pair arranged on the side far or opposite from the light source.

According to at least an embodiment of the present invention, in a particle counter equipped with a measuring area which is irradiated with laser light and counts the particles in the area to be measured, a pair of lenses, each lens of which has a convex- or concave-curved surface on the side near the measuring area and a flat surface on the side far from the measuring area, are arranged interposing the measuring area between them. A light-transmitting fluid path in which particles flow is provided between the pair of lenses, and a reflective member for reflecting laser light is provided on the flat surface of one of the lenses of the pair on the side far or opposite from the light source; therefore, the laser light that was irradiated onto the measuring area but did not strike particles flowing in the transmitting fluid path is transmitted through the one lens of the pair on the side far or opposite from the light source, reflected at the above mentioned reflective member, and then returned to the measuring area again.

In this way, the particles flowing in the light-transmitting fluid path can be irradiated first by the laser light emitted from the light source toward the measuring area and then by the laser light which once has passed through the measuring area and then returned to the measuring area; thus, the irradiation light intensity in the measuring area can be about two times stronger (less than two times if the reflective ratio is considered), thus increasing the sensitivity of the particle counter.

The above-described embodiment (1) or (1A) is capable of increasing the irradiation light intensity in the measuring area by about 2 times without using a light source of high energy density or an expensive light source having a short wavelength, thus preventing increase in manufacturing cost. Further, at least an embodiment of the present invention is for increasing the irradiation light intensity by using a pair of lenses and a reflective member; therefore, the particle counter is prevented from getting larger.

In particular, in at least an embodiment of the present invention (1) or (1A), a pair of lenses are arranged such that the convex-curved surfaces thereof are opposed to each other via the measuring area which is irradiated by laser light; therefore, the different effect can be demonstrated from that of the light-scattering particle counter in which the laser light, which was irradiated onto the measuring area but did not strike particles, is reflected at the mirrors, etc. and returned to the measuring area again. More specifically described, when the laser light, which was irradiated to the measuring area but did not strike particles, is simply reflected at optical components such as a mirror, corner cube, cat's eye, etc., scattered light (interface reflection, etc.) is caused by the interface between the optical components and the surrounding medium (such as air) (which means that the laser light that has hit the reflective plate does not return properly), causing loss of light. On the other hand, as in at least an embodiment of the present invention, when a pair of lenses are arranged such that the convex-curved surfaces thereof are opposed to each other via the measuring area, the light is temporarily converted into flat band-like beams at a focal point, and the laser light that expands as it travels away from the focal point is refracted at the convex-curved surface of one lens of the pair on the side far from the light source; after being transmitted through the convex-curved surface, the light beam is reshaped to be the same shape (parallel beam) as that obtained right before the laser light exits the one lens of the pair on the side close to the light source. Then, the parallel beam is reflected at the reflective member; therefore, the scattered light which is normally caused by the interface hardly occurs (the laser light that has hit the reflective member returns properly). In this manner, the light beam can be reshaped at the convex-curved surface of the lens arranged on the side far or opposite from the light source and also the laser light can be properly returned at the flat surface so that the interface itself is reduced, resulting in reduced scattered light by the interface (the laser light that has hit the reflective member is mostly returned) and in reduced loss of light and increased irradiation light intensity in the measuring area by about two times.

The “pair of lenses” here include a pair of totally identical lenses, needless to say, but they need not be of the same material and same type. For example, lenses of different material, size or shape may be used as long as the convex-curved surface is arranged on the side near the measuring area, the flat surface is arranged on the side far from the measuring area, and the parallel beam is reshaped at the convex-curved surface and the light is reflected at (the reflective member provided on) the flat surface.

The “pair of lenses” in at least an embodiment of the present invention (1A) may use, for one of the lenses used to return (reflect) the beam, a reflective member (such as a cylinder mirror, an aspherical mirror such as a toric mirror, etc.) that reflects the laser light, which temporarily becomes a flat, band-like beam and then expands as it travels away from a focal point, and converts the light back to the flat-band-like beam a the same focal point as that of the lens arranged on the side close to the light source.

Also, in the embodiment (1) or (1A), any kind of lenses may be used for the “pair of lenses”. Any kind such as a cylinder lens, a toric lens, a rod lens, a ball lens, a convex lens, or an achromatic lens may be used as long as the convex-curved surface is arranged on the side near the measuring area and the flat surface is arranged on the side far from the measuring area.

In at least an embodiment of the present invention (1A), “the light-transmitting fluid path” in which particles flow is provided between the pair of lenses; the light-transmitting fluid path may be a tube with transmittance, a hole may be bored in a transmitting resin to form a fluid path, or two lenses, each of which has a flat surface having a semi-cylindrical groove, may be adhered with the grooves thereof together to form a fluid path.

Further, in the embodiment (1) or (1A), the reflective member is “provided” on the flat surface of one lens of the pair arranged on the side far or opposite from the light source, but how it is constructed does not matter: the reflective member may be attached later on the flat surface of the lens or the reflective member is formed integral with the flat surface of the lens.

(2) or (2A) The particle counter of (1) or (1A) wherein the pair of lenses are the identical cylinder lenses which are arranged such that the cylinder surfaces thereof are opposed to each other via the measuring area. Note that the above (2) corresponds to the above-described embodiment (1), the above (2A) to the above-described embodiment (1A).

According to at least an embodiment of the present invention (2) or (2A), a pair of identical cylinder lenses are arranged such that the cylinder surfaces thereof are opposed to each other via the measuring area; therefore, while the number of different components is reduced contributing to reduction in manufacturing cost, the irradiation light intensity in the measuring area is increased to about 2 times stronger, thus increasing the sensitivity of the particle counter.

Also, a pair of “identical” cylinder lenses are used to increase accuracy of beam-shaping performed at the convex-curved surface in the one lens of the pair arranged on the side far or opposite from the light source (to reshape the beams with more accuracy to the state (parallel beam) obtained immediately before the laser light exits the one lens of the pair arranged on the side near the light source), resulting in reduced loss of light.

(3) or (3A) The particle counter of (1) or (2) or (1A) or (2A) wherein a polarizing plate and a λ/4 plate are positioned between the light source and the one lens of the pair arranged close to the light source. Note that the above (3) corresponds to the above-described embodiment (1) or (2), the above (3A) to the above-described embodiment (1A) or (2A).

According to at least an embodiment of the present invention described in (3) or (3A), a polarizing plate and a λ/4 plate are positioned between the light source and the one lens of the pair arranged close to the light source; therefore, the laser light reflected from the reflective member is prevented from returning all the way to the light source, thus preventing damage to the light source. More specifically described, of the laser light emitted from the light source, only the light having a plane of vibration in a specific direction is transmitted through the polarizing plate, and the λ/4 plate causes a quarter wavelength phase difference to the linearly-polarized light transmitted through the polarizing plate. Then, a further quarter wavelength phase difference is caused by the λ/4 plate to the returning laser light that has traveled through the lens arranged close to the light source, the measuring area, the lens (reflective member) arranged far or opposite from the light source, the measuring area, and the lens close to the light source. Consequently the laser light having a plane of vibration in the direction perpendicular to the linearly-polarized light that has transmitted first is returned to the polarizing plate; therefore, the returning laser light is light-shielded by the polarizing plate, by which the light is prevented from returning to the light source, preventing damage to the light source.

(4) A particle counter which irradiates a measuring area with laser light emitted from a light source and counts particles present in the measuring area based on the scattered light generated by the particles, comprising a light-receiving device for detecting the scattered light and a first mirror surface for condensing the reflected light onto the light-receiving surface of the light-receiving device, wherein the scattered light directly enters the light-receiving surface of the light-receiving device, and also is reflected from the first mirror and then enters the light-receiving surface of the light-receiving device.

According to at least an embodiment of the present invention, the particle counter which is equipped with the measuring area onto which the laser light is irradiated and counts the particle in the measuring area, as describe above is provided with the light-receiving device for detecting the scattered light and the first mirror surface for condensing the reflected light onto the light-receiving surface of the light-receiving device, and some of the scattered light directly enters the light-receiving surface of the light-receiving device and while the other scattered light is reflected from the first mirror and then enters the light-receiving surface of the light-receiving device. Therefore, scattered light other than the scattered light directly entering the light-receiving surface of the light-receiving device can be detected.

(4A) A particle counter which irradiates a measuring area with laser light emitted from a light source and counts particles present in the measuring area based on the scattered light generated by the particles, comprising a light-receiving device for detecting the scattered light, a first lens having a first mirror surface for condensing the reflected light onto the light-receiving surface of the light-receiving device, a second lens opposed to the first lens, and a light-transmitting fluid path, in which the particles flow, formed between the first lens and the second lens, wherein some of the scattered light directly enters the light-receiving surface of the light-receiving device while the other scattered light is reflected from the first mirror and then enters the light-receiving surface of the light-receiving device.

According to at least an embodiment of the present invention, a particle counter which is equipped with a measuring area to be irradiated by laser light and counts the particles in the measuring area is provided with a light-receiving device for detecting the scattered light, a first lens having a first mirror surface for condensing the reflected light onto the light-receiving surface of the light-receiving device, a second lens opposed to the first lens, and a light-transmitting fluid path, in which the particles flow, formed between the first lens and the second lens, wherein some of the scattered light directly enters the light-receiving surface of the light-receiving device while the other scattered light is reflected from the first mirror and then enters the light-receiving surface of the light-receiving device. Therefore, scattered light other than the scattered light directly entering the light-receiving surface of the light-receiving device can be detected.

Consequently, at least an embodiment of the present invention (4) or (4A) can realize a high NA even when not a highly sensitive light-receiving device but a normal light-receiving device is used, resulting in reduced manufacturing cost and increased sensitivity of the particle counter.

Particularly, at least an embodiment of the present invention (4) or (4A) does not use lenses in a focusing system unlike conventional technology. In other words, at least an embodiment of the present invention does not use lenses having a characteristic in that the index of refraction changes as the wavelength of the incident light changes, which in turn changes the focal point. Therefore, even if the wavelength of laser light emitted from the light source is changed (for example, shortened) in the future, there is no need to change the focusing system and a particle counter with high usage can be provided.

For “the first mirror surface”, an elliptic mirror can be used, for example; however, it can be any mirror surface capable of condensing the reflected light onto the light-receiving surface of the light-receiving device.

In at least an embodiment of the present invention (4A), “the first lens” or “the second lens” is an optical component having a refraction power or an effect of bending light, and can be a transmitting resin lens or a transmitting glass lens, for example. Also, a fluid such as water is poured into a container having transmittance to provide a lens function. Further, “the first mirror surface” is formed by applying a mirror coating on the first lens.

(5) or (5A) The particle counter described in (4) or (4A) wherein the first mirror surface is opposed to the light-receiving device via the measuring area. Note that the above-mentioned (5) corresponds to the present embodiment (4) and the above-mentioned (5A) to the present embodiment (4A).

According to at least an embodiment of the present invention (5) or (5A), the first mirror surface is opposed to the light-receiving device via the measuring area; therefore, the scattered light traveling in the opposite direction from the light-receiving surface of the light-receiving device can be reflected at the first mirror surface and directed to the light-receiving surface of the light-receiving device. Thus, a high NA can be realized with fewer reflections (one time), resulting in reduced manufacturing cost and increased sensitivity of the particle counter.

Generally, the reflective ratio in the mirror surface is less than 1 (for example, 0.7) and light energy is converted to thermal energy at every reflection; thus, repeated reflections reduce the light intensity. However, according to at least an embodiment of the present invention, the scattered light can be directed to the light-receiving surface of the light-receiving device by fewer reflections (one time); therefore, while the decrease of the light intensity is kept to a minimum, the sensitivity of the particle counter can be increased.

(6) The particle counter described in (5) wherein in the vicinity of the light-receiving surface of the light-receiving device, a second mirror surface is arranged for condensing the reflected light to the measuring area.

According to at least an embodiment of the present invention, in the vicinity of the above-mentioned light-receiving surface of the light-receiving device, a second mirror surface is arranged for condensing the reflected light to the measuring area; therefore, the scattered light which is directed toward the light-receiving device but outside of the light-receiving surface of the light-receiving device can be temporarily returned to the measuring area. Then, the light that has returned to the measuring area is reflected at the above-mentioned first mirror and directed to the light-receiving surface of the light-receiving device.

(6A) The particle counter described in (5A) wherein in the vicinity of the light-receiving surface of the light-receiving device and on part of the second lens surface, a second mirror surface is provided for condensing the reflected light to the measuring area.

According to at least an embodiment of the present invention, in the vicinity of the above-mentioned light-receiving surface of the light-receiving device and on part of the second lens surface, a second mirror surface is provided for condensing the reflected light to the measuring area; therefore, the scattered light which is directed toward the light-receiving device but outside of the light-receiving surface of the light-receiving device can be temporarily returned to the measuring area. Then, the light that has returned to the measuring area is reflected at the above-mentioned first mirror surface and directed to the light-receiving surface of the light-receiving device.

Therefore, compared to the case using only the first mirror surface, at least an embodiment of the present invention (6) or (6A) can realize an even higher NA, resulting in reduced manufacturing cost and increased sensitivity of the particle counter.

The “second mirror surface” may be a spherical mirror; however, it can be any mirror surface as long as it is capable of condensing the reflected light to the measuring area.

(7) A particle counter which irradiates a measuring area with laser light emitted from a light source and counts particles present in the measuring area based on the scattered light generated by the particles, comprising a light-receiving device for detecting the scattered light and multiple pairs of lenses arranged via the measuring area in the plane which includes the measuring area and parallel to the light-receiving surface of the light-receiving device, wherein each lens of each pair respectively has a convex-curved surface on the side near the measuring area and a flat surface on the side far from the measuring area, and a reflective member for reflecting laser light is provided on the flat surface of the lens of each pair which is arranged on the side far or opposite from the light source.

According to at least an embodiment of the present invention, the light-receiving device for detecting the scattered light and multiple pairs of the lenses arranged via the measuring area are provided in the plane which includes the measuring area and is parallel to the light-receiving surface of the light-receiving device; each lens of each pair respectively has a convex-curved surface on the side near the measuring area and a flat surface on the side far from the measuring area, and a reflective member for reflecting laser light is provided on the flat surface of the lens of each pair which is arranged on the side far or opposite from the light source. Therefore, compared to the case using only one pair of lenses, the light intensity can be increased by multiple times, resulting in further increased sensitivity of the particle counter.

(7A) A particle counter which irradiates a measuring area with laser light emitted from a light source and counts particles present in the measuring area based on the scattered light generated by the particles, comprising a light-receiving device for detecting the scattered light and multiple pairs of lenses arranged via the measuring area in the plane which includes the measuring area and is parallel to the light-receiving surface of the light-receiving device, wherein each lens of each pair respectively has a convex- or concave-curved surface on the side near the measuring area and a flat surface on the side far from the measuring area, a light-transmitting fluid path in which the particles flow is provided between the pair of lenses and a reflective member for reflecting laser light is provided on the flat surface of the lens of each pair which is arranged on the side far or opposite from the light source.

According to at least an embodiment of the present invention, the light-receiving device for detecting the scattered light and multiple pairs of lenses arranged via the measuring area are provided in the plane which includes the measuring area and is parallel to the light-receiving surface of the light-receiving device; each lens of each pair has a convex- or concave-curved surface on the side near the measuring area and a flat surface on the side far from the measuring area. And a light-transmitting fluid path in which the particles flow is provided between each pair of lenses and a reflective member for reflecting laser light is provided on the flat surface of the lens of each pair which is arranged on the side far or opposite from the light source. Therefore, compared to the case using only one pair of lenses, the light intensity can be increased by several times, resulting in further increased sensitivity of the particle counter.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A particle counter for detecting and counting particles in a fluid to be measured comprising:
a measuring section structured to detect said particles; and
a control section structured to process an output signal from said measuring section;
wherein a signal to issue a warning is generated when an abnormality occurs.

2. The particle counter as set forth in claim 1 wherein:
said measuring section comprises a photo detector structured to optically detect said particles;
said control section comprises:
a counter section structured to count particles based on an output from said photo detector;
a mode switching section structured to switch a counting mode of said counter section to a counting mode selected from pre-set modes,
and a parameter storage section structured to store a warning level, wherein the warning level is a particle counting value at which a warning set corresponding to said counting mode is issued; when said particle counting value exceeds said warning level; and
a signal to issue a warning is generated.

3. A particle counting device comprising:
a particle counter comprising:
a measuring section structured to detect particles in a fluid to be measured;
and a control section structured to process an output signal from said measuring section, said control section being permanently placed in a necessary observation location to issue a warning when an abnormality occurs in the detection of said particles; and
an information processing device structured to communicate with said particle counter, and structured to process the measurement result obtained by said particle counter and display its results.

4. The particle counting device as set forth in claim 3 wherein said information processing section comprises a data accumulating section structured to accumulate said measurement data from said particle counter, and a trend graph display section structured to graph and display the trend of the measurement data based on the measurement data accumulated in said accumulating section and/or the measurement data from said particle counter.

5. The particle counting device as set forth in claim 4, wherein
said control section of said particle counter is provided with a counter section structured to count the number of particles based on the output signal from said measuring section and a mode switching section structured to switch and set a counting mode of said counter section to a counting mode selected from pre-set modes; and
said trend graph displaying section of said information processing device displays the measurement data by a graph corresponding to the counting mode set by said mode switching section.

6. The particle counting device as set forth in claim 3 wherein an environmental measuring device and a processing status data input device are provided to communicate with said information processing device.

7. The particle counting device as set forth in claim 3 wherein communication between said particle counter and said information processing device can be either a permanent connection or an intermittent connection.

8. A particle counting system comprising:
a plurality of particle counters structured to detect and count particles in a fluid to be measured; and
an information processing device structured to process the counting results obtained from said plurality of particle counters;
wherein said plurality of particle counters are electrically connected to said information processing device in multiple and in parallel.

9. A particle counting system comprising:
a plurality of particle counters structured to detect and count particles in a fluid to be measured,
wherein, to one of said plurality of particle counters, the other particle counters are electrically connected in multiple and in parallel.

10. The particle counting system as set forth in claim 8 wherein said information processing device comprises a counting result processor structured to process every counting result, and when said plurality of counters are operated in multiple and in parallel, counting results from a plurality of said particle counters are collected in said counting result processor.

11. The particle counting system as set forth in claim 9 wherein said one particle counter is provided with a counting result processor structured to process every counting result, and when said plurality of particle counters are operated in multiple and in parallel, counting results from said multiple particle counters are collected in said counting result processor.

12. The particle counting system as set forth in claim 10 wherein said counting result processor adds up the collected counting results.

13. The particle counting system as set forth in claim 8 wherein a suction device structured to suck a fluid to be measured is connected to each of said plurality of particle counters; and
said multiple suction means are arranged in a specific monitoring area for detecting and counting particles in a fluid to be measured in the specific monitoring area.

14. A method of using a particle counting system which comprises a plurality of particle counters for detecting and counting particles in a fluid to be measured and an information processing device for processing counting results obtained from said plurality of particle counters and in which plurality of multiple particle counters are electrically connected to said information processing device in multiple and in parallel, the method comprising:
operating said multiple particle counters in multiple and in parallel.

15. A use method of a particle counting system which comprises a plurality of particle counters for detecting and counting particles in a fluid to be measured and in which, to one of said plurality of particle counters, the other particle counters are electrically connected in multiple and in parallel, the method comprising:
operating said multiple particle counters in multiple and in parallel.

16. A particle counter comprising:
a light source structured to emit laser light;
a projection lens system structured to condense said laser light onto a sample fluid;
a light-receiving lens system structured to condense scattered light generated by irradiating particles in said sample fluid with said laser light; and
a photo detector structured to detect condensed scattered light;
wherein said light-receiving lens system comprises two lenses having an aperture of 0.45 or larger.

17. The particle counter as set forth in claim 16 wherein said light-receiving lens system is made of resin.

18. The particle counter as set forth in claim 16 wherein said projection lens system comprises a condenser lens structured to condense said laser light onto said sample fluid and said condenser lens is identical with the two lenses of said light-receiving lens system.

19. The particle counter as set forth in claim 18 wherein said condenser lens is made of resin.

20. The particle counter as set forth in claim 16 wherein said light source is a laser diode having a wavelength of 800 nm or less and said light-receiving lens system and said condenser lens are designed to have a wavelength of 800 nm or less.

21. The particle counter as set forth in claim 20 wherein a deflection direction of said laser light is perpendicular to a plane including an optical axis of said laser diode and a direction in which said scattered light is incident on said photo detector.

22. The particle counter as set forth in claim 21 wherein said laser light is formed to be a band-like laser beam and wider than the size of said sample fluid, and said sample fluid flows across at a right angle with respect to the traveling direction of said band-like laser beam; and in a wider direction of said band-like laser beam, said band-like laser beam travels across an entire width of said sample fluid.

23. A particle counter for irradiating a measuring area with laser light from a light source and for counting particles based on scattered light generated by particles present in said measuring area, comprising:
a pair of lenses arranged interposing said measuring area between them, said lenses of the pair respectively having a convex-curved or concave-curved surface on a side near said measuring area and a flat surface on a side far from said measuring area;
a light-transmitting fluid path in which said particles flow provided between said lenses of the pair;
and a reflective member structured to reflect laser light provided on said flat surface of a lens of said pair arranged on a side far from said light source.

24. The particle counting device as set forth in claim 3, wherein the environmental measuring device is a wind velocity measuring device, a temperature measuring device, or an illumination measuring device.

25. The particle counting system as set forth in claim 9, wherein
a suction device structured to suck a fluid to be measured is connected to each of said plurality of particle counters; and
said multiple suction means are arranged in a specific monitoring area for detecting and counting particles in a fluid to be measured in the specific monitoring area.
